(19) United States
(12) Patent Application Publication
(10) Pub. No.: US 2026/0295475 A1
(43) Pub. Date: Oct. 1, 2026

(54) FILTER ARRANGEMENTS FOR LIQUIDS AND METHODS OF USE

(71) Applicant: Donaldson Company, Inc., Bloomington, MN (US)

(72) Inventors: Michael S. Courneya, St. Louis Park, MN (US); Kurt B. Joscher, Burnsville, MN (US)

(21) Appl. No.: 19/575,248

(22) Filed: Mar. 23, 2026

Related U.S. Application Data
(60) Provisional application No. 63/777,216, filed on Mar. 25, 2025.

(51) Int. Cl. B01D 27/08; B01D 29/58

(52) U.S. Cl. CPC B01D 27/08; B01D 29/58; B01D 2201/12; B01D 2201/291; B01D 2201/342; B01D 2201/347

(57) ABSTRACT

A filter cartridge for liquid filtration includes a treatment media construction with a first end construction having a flexural member along its outer periphery. The flexural member is radially deflectable and can also deflect tangentially or axially. An interface member extends from the flexural member and is supported by an arm arrangement positioned radially outside a circumferential skirt. During installation, the filter cartridge is placed into a filter bowl and the bowl-cartridge combination is rotated less than 90 degrees to engage with a filter head. As the combination rotates, the flexural member deflects radially inward as the interface member slides along a projection in the filter head. When the interface member passes over the projection, the flexural member snaps back, producing an audible click to confirm proper installation.

The first end construction also includes ramps that push a displaceable piece on the filter head from a blocking position to a clearance position during rotation, ensuring proper alignment and installation.

### CROSS-REFERENCE TO RELATED APPLICATION

This application claims the benefit of U.S. Provisional Application No. 63/777,216, filed Mar. 25, 2025, the disclosure of which is hereby incorporated herein by reference.

### TECHNICAL FIELD

This disclosure relates to liquid filter arrangements useable, for example, to filter any liquids, including fuel, hydraulic fluids, and lubricating fluids. A filter head is described on which a serviceable filter cartridge arrangement is positioned in use. Methods of assembly and use are also provided.

### BACKGROUND

Circulating liquid systems such as fuel, hydraulic fluids, and lubricating fluids, typically require a filter arrangement. The filter arrangement is typically positioned so that the fluids are filtered by passage through filter media positioned within the filter arrangement. Typically the filter arrangement is configured so that the componentry containing the media is a service part, i.e., the media can, periodically, be removed and be replaced.

There are two common types of liquid filter arrangements. The first, typically referred to herein as a “spin-on” type, involves a filter head installed on equipment, and a spin-on filter member or cartridge. The filter member or cartridge is often referred to as “spin-on” because the assembly including the filter media is typically secured to the filter head by threading. In spin-on arrangements, the filter media is typically non-removably secured within a shell or housing as a housing/media combination, and the entire housing/media combination, as a filter member or cartridge, is removed and replaced during servicing.

The second common type of liquid filter arrangement is referred to herein as a bowl/cartridge arrangement. With a bowl/cartridge arrangement, the filter head is again installed on the equipment. The filter media, however, is contained within a filter cartridge in a form removably positioned within a housing or shell. A housing/cartridge combination is again mounted on the filter head for use. However, during servicing, the housing is disconnected from the filter head, the media contained within the housing or shell is replaced, and the same shell or housing, with the replacement media inside, is then remounted on the filter head.

A well-functioning filter arrangement is important in protecting downstream equipment, such as an engine or hydraulic machinery. Improvements in filter arrangements are always desirable.

This disclosure also concerns improvements to filter arrangements described in WO 2021/087125, incorporated herein by reference. The filter arrangements can include filtering many different types of fluids, especially liquid, including, e.g. fuel, lubricants, hydraulic oil, air/oil separation, coolant, urea, water, etc.

### SUMMARY

In one aspect, a filter cartridge is provided comprising a treatment media construction having a first end and an opposite second end; a first end construction adjacent to the first end of the media construction, the first end construction having an outer periphery; and a flexural member along the outer periphery of the end construction, the flexural member being radially deflectable and at least one of: tangentially deflectable or axially deflectable.

In preferred embodiments, the treatment media construction comprises a cylindrical construction of pleated filter media defining an open interior volume, and the first end construction includes an opening providing communication with the open interior volume.

In example arrangements, the first end construction includes an axial portion having an exterior surface and an opposite interior surface, and a circumferential skirt extending from the interior surface of the axial portion, the circumferential skirt forming the outer periphery, the opening in the first end construction being defined by an open spigot; and the flexural member includes an interface member extending at least 1-25 mm axially spaced from the exterior surface of the axial portion.

In some embodiments, the interface member extends a greater distance away from the exterior surface of the axial portion than the open spigot, while in other embodiments, the interface member extends a smaller distance away from the exterior surface of the axial portion than the open spigot, and in still other embodiments, the interface member extends an equal distance away from the exterior surface of the axial portion as the open spigot.

Preferred arrangements further include a seal member held by the first end construction, which in examples is mounted on the open spigot and can be one of: an axial seal, an inner radial seal, an outer radial seal, or a grommet.

In many arrangements, the first end construction includes a radially projecting lip arrangement between the axial portion and the circumferential skirt, and the flexural member is radially spaced from the circumferential skirt by a distance of no greater than 10 mm.

In example embodiments, the interface member is supported by an arm arrangement positioned radially outside of the circumferential skirt, and the filter cartridge includes a plurality of flexural members circumferentially spaced along the outer periphery, each of the flexural members including its own interface member supported by a respective arm arrangement.

In some arrangements, the filter cartridge further includes a plurality of ribs projecting radially from the circumferential skirt of the first end construction sized to engage a rim of a filter bowl when the cartridge is inserted into a filter bowl, wherein each of the flexural members is positioned between two of the ribs.

In preferred embodiments, each of the arm arrangements extends from a respective one of the ribs, each of the interface members is centered between two of the ribs, and each of the arm arrangements includes a first hook shaped arm and a second hook shaped arm with the respective interface member therebetween.

In example arrangements, the circumferential skirt of the first end construction includes a free-edge rim, each of the first hook shaped arms is secured to and extends radially outwardly and axially from the circumferential skirt to define a first open pocket away from the axial portion and between the free-edge rim and the first hook shaped arm, and each of the second hook shaped arms is secured to and extends radially outwardly and axially from the circumferential skirt to define a second open pocket away from the axial portion between the free-edge rim and the second hook shaped arm.

Preferred arrangements further include a second end construction secured to the second end of the media construction and a blocking piece to ensure proper engagement between the filter cartridge and a receiving member, the blocking piece being circumferentially spaced adjacent to one of the ribs and extending radially outwardly from the first end construction.

In some embodiments, the first end construction further includes a ramp circumferentially spaced from the flexural member, the ramp being constructed and arranged to push a displaceable piece on a mating filter head from a blocking position to a clearance position, and in example arrangements includes a plurality of ramps on the axial portion of the first end construction circumferentially spaced from each other, each ramp being in alignment with a respective one of the ribs and having an average slope from the axial portion to an end peak of 7-65°.

In preferred embodiments, the flexural member is radially inwardly flexible or radially outwardly flexible, wherein a distance of radial flexibility of the flexural member compared to a diameter of the first end construction is between 0.7% to 16%.

In example arrangements, the flexural member is constructed and arranged such that to displace the flexural member radially by 1.2 mm at the interface member requires a force of 0.3 lbs to 10 lbs, and to displace the interface member in a direction toward the treatment media construction 2 mm requires a force of between 0.2-15 pounds.

In some embodiments, the flexural member comprises a material having a flexural modulus of 1-10 GPa per ASTM D790, and the flexural member is configured to produce an audible click of at least 40-80 dBA while the filter cartridge is connecting to a filter head, referenced to 20 uPa in accordance with ISO 1683.

In another aspect, a method of installing a filter cartridge is provided comprising: placing a filter cartridge into a filter bowl to provide a bowl-cartridge combination, the cartridge having at least one flexural member; mounting the bowl-cartridge combination on the head by rotating the bowl-cartridge combination less than 90° to engage connections between the filter bowl combination and the filter head until the flexural member snaps over a projection in the filter head; and while rotating, compressing a seal member on the filter cartridge to form a seal between and against the head and the filter cartridge.

In preferred methods, the step of snapping the flexural member over a projection includes deflecting the flexural member in a radial direction over the projection in the filter head, and deflecting the flexural member radially inwardly over the projection in the filter head.

In some method embodiments, the step of rotating the bowl-cartridge combination includes displacing a displaceable piece on the filter head from a blocking position to a clearance position, wherein the displaceable piece comprises a pivotable pin on the filter head positioned to pivot between the blocking position and the clearance position, and the step of rotating includes using a ramp on the filter cartridge to pivot the pin.

In example methods, before the step of placing the filter cartridge into the filter bowl, the method includes removing a used filter cartridge from the filter bowl, wherein the step of removing includes rotating the used filter cartridge while mounted in the filter bowl relative to the filter head and deflecting a flexural member on the used filter cartridge at least one, or both, axially and tangentially to move the flexural member on the used filter cartridge over the projection in the filter head.

In some method arrangements, the step of removing includes engaging a ramp on the used filter cartridge against a protrusion in the filter head to axially move the used filter cartridge away from the filter head, and the step of rotating the bowl-cartridge combination includes producing an audible click of at least 40-80 dBA when the flexural member snaps over the projection in the filter head.

In another aspect, a filter cartridge for removable connection to a filter head is provided comprising: a treatment media construction; and a click device on the filter cartridge configured to produce an audible click of at least 40-80 dBA while the filter cartridge is connecting to a filter head, referenced to 20 uPa in accordance with ISO 1683.

In preferred embodiments, the treatment media construction has a first end and an opposite second end, a first end construction is adjacent to the first end of the media construction, and the click device is attached to the first end construction.

In example arrangements, the media construction comprises a cylindrical construction of pleated filter media defining an open interior volume, the first end construction includes an open spigot providing communication with the open interior volume, and the click device comprises a flexural member that is radially deflectable and at least one of: tangentially deflectable or axially deflectable.

In some embodiments, the flexural member includes an interface member supported by an arm arrangement, wherein the first end construction includes an axial portion having an exterior surface and an opposite interior surface, and a circumferential skirt extending from the interior surface of the axial portion forming an outer periphery, and the arm arrangement is positioned radially outside of the circumferential skirt.

In preferred arrangements, the flexural member is radially spaced from the circumferential skirt by a distance of no greater than 10 mm, the interface member extends at least 1-25 mm away from the exterior surface of the axial portion, and the filter cartridge further includes a second end construction secured to the second end of the media construction.

In example embodiments, the filter cartridge includes a plurality of click devices or a plurality of flexural members, further including a plurality of ribs projecting radially from the circumferential skirt of the first end construction sized to engage a rim of a filter bowl when the cartridge is inserted into a filter bowl, wherein each of the flexural members is positioned between two of the ribs.

In some arrangements, the filter cartridge further comprises a blocking piece to ensure proper engagement between the filter cartridge and a receiving member, the blocking piece being circumferentially spaced adjacent to one of the ribs and extending radially outwardly from the first end construction.

In preferred embodiments, the first end construction further includes a ramp constructed and arranged to push a displaceable piece on a mating filter head from a blocking position to a clearance position, and in example arrangements includes a plurality of ramps on the first end construction circumferentially spaced from each other, each ramp being in alignment with a respective one of the ribs.

In another aspect, a method of installing a filter cartridge is provided comprising: placing a filter cartridge into a filter bowl to provide a bowl-cartridge combination, the cartridge having at least one click device; mounting the bowl-cartridge combination on the head by rotating the bowl-cartridge combination less than 90° to engage connections between the filter bowl combination and the filter head to produce an audible click of at least 40-80 dBA referenced to 20 uPa in accordance with ISO 1683; and while rotating, compressing a seal member on the filter cartridge to form a seal between and against the head and the filter cartridge.

In preferred methods, the cartridge includes a plurality of click devices and the step of rotating the bowl-cartridge combination includes each of the click devices producing an audible click of at least 40-80 dBA, wherein the click device comprises a flexural member and the step of rotating includes snapping the flexural member over a projection in the filter head.

In another aspect, a filter cartridge is provided comprising a treatment media construction having a first end and an opposite second end; a first end construction adjacent to the first end of the media construction, the first end construction including an axial portion having an exterior surface and an opposite interior surface, a circumferential skirt extending from the interior surface of the axial portion, and an outer rim; and at least one actuator positioned on the axial portion of the first end construction, the actuator being constructed and arranged to push a displaceable piece on a mating filter head from a blocking position to a clearance position.

In preferred embodiments, the at least one actuator comprises at least one ramp having a slope surface positioned on the axial portion of the first end construction, the ramp pushing the displaceable piece along the slope surface, and the at least one ramp is located on the axial portion along the outer rim.

In example arrangements, the at least one ramp includes a plurality of ramps on the axial portion of the first end construction circumferentially spaced from each other, each of the ramps of the plurality of ramps is located along the outer rim, and the plurality of ramps includes at least two ramps or at least three ramps evenly circumferentially spaced from each other.

In some embodiments, the outer rim of the first end construction includes a plurality of radially extending lip sections projecting radially outwardly from the circumferential skirt and the axial portion, a plurality of non-lip sections circumferentially between the lip sections, and at least one ramp of the plurality of ramps positioned along the outer rim and bridging between each one of the non-lip sections and adjacent lip section.

In preferred arrangements, the slope surface of each ramp of the plurality of ramps has a curved ramp surface ending in a free end tip, the curved ramp surface has an average slope from the axial portion to the free end tip of 7-65°, and the slope surface extends from a free end tip to the axial portion in a clockwise direction when viewed from a position above the first end construction.

In example embodiments, the filter cartridge further includes at least one extension projecting radially from the circumferential skirt of the first end construction sized to engage a rim of a filter bowl when the cartridge is inserted into a filter bowl, wherein the at least one extension includes a plurality of ribs, and each ramp of the plurality of ramps is at least partially in alignment with a respective one of the ribs.

In some arrangements, the treatment media construction comprises a cylindrical construction of pleated filter media defining an open interior volume, the first end construction includes an opening providing communication with the open interior volume, and a seal member held by the first end construction.

In preferred embodiments, the opening comprises a spigot and a seal member is mounted on the spigot, wherein the seal member is one of: an axial seal, an inner radial seal, an outer radial seal, or a grommet, and the filter cartridge further includes a second end construction secured to the second end of the media construction.

In another aspect, a method of mounting a filter assembly to a filter head is provided comprising: inserting a filter assembly into a filter head to displace a displaceable piece on the filter head; and rotating the filter assembly relative to the filter head to move the piece from a blocking position to a clearance position to permit connection between the filter assembly and the filter head.

In preferred methods, the displaceable piece comprises a pivotable pin on the filter head positioned to pivot between the blocking position and the clearance position, the step of rotating includes using a first end construction on the filter assembly to pivot the pin, and the filter assembly includes a filter cartridge removably oriented within a filter bowl with the step of rotating including rotating the filter assembly less than 90° to engage connections between the filter bowl and the filter head.

In example methods, the first end construction includes an axial portion having an exterior surface and an outer rim with at least one actuator positioned on the axial portion, and the step of using the first end construction includes using the at least one actuator to push the displaceable piece from a blocking position to a clearance position.

In some method arrangements, the at least one actuator comprises at least one ramp having a slope surface positioned on the axial portion, the step of using the at least one actuator includes pushing the displaceable piece along the slope surface, and the at least one ramp includes a plurality of ramps circumferentially spaced from each other, with each ramp being used to push the displaceable piece from the blocking position to the clearance position.

In preferred methods, each of the ramps is located along the outer rim, the plurality includes at least two ramps or at least three ramps evenly circumferentially spaced from each other, and the slope surface of each ramp has a curved ramp surface ending in a free end tip with an average slope of 7-65°.

In example embodiments, the method further includes providing a treatment media construction having a first end and an opposite second end comprising a cylindrical construction of pleated filter media defining an open interior volume, positioning the first end construction adjacent to the first end of the media construction with an opening providing communication with the open interior volume, and compressing a seal member held by the first end construction to form a seal between and against the filter head and the filter cartridge.

In another aspect, a filter cartridge is provided comprising a treatment media construction having an outer perimeter and a detent at or outside of the outer perimeter to prevent motion of the filter cartridge.

In preferred embodiments, the filter cartridge further includes a beam supporting the detent, and the beam is located outside of the outer perimeter of the treatment media construction.

In example arrangements, the treatment media construction has a first end and an opposite second end, a first end construction is adjacent to the first end of the media construction, and the beam extends radially outwardly from the first end construction.

In many preferred arrangements, the detent is centered on the beam and projects axially from the beam in a direction away from the treatment media construction.

In some embodiments, the treatment media construction and first end construction are generally cylindrical, and the filter cartridge includes a plurality of detent-supporting beams circumferentially spaced from each other, each of the beams extending radially outwardly from the first end construction, and each of the detents projecting axially from its supporting beam.

In examples, the first end construction includes an outer radial wall and an axial wall covering the first end of the media construction, and a plurality of ribs projecting radially from the outer radial wall of the first end construction, each of the ribs having a terminal end sized to engage a rim of a filter bowl when the cartridge is inserted into a filter bowl.

In some arrangements, each detent-supporting beam extends between two of the ribs, and preferred arrangements further include a second end cap secured to the second end of the media construction.

In example arrangements, the media construction comprises a cylindrical construction of pleated filter media defining an open interior volume, and the first end construction includes an open spigot holding a radial seal member providing communication with the open interior volume.

In some embodiments, the radial seal member is on an outer wall of the spigot to provide outwardly directed radial seal with a filter head when the filter cartridge is attached to a filter head.

Some examples further comprise a blocking piece to ensure proper engagement between the filter cartridge and a receiving member, the blocking piece being circumferentially spaced adjacent to one of the ribs.

In some examples, the first end construction further includes a ramp circumferentially adjacent to each detent-supporting beam, the ramp being constructed and arranged to push a displaceable piece on a mating filter head from a blocking position to a clearance position.

In another aspect, a method of installing a filter cartridge is provided comprising: placing a filter cartridge into a filter bowl to provide a bowl-cartridge combination, the cartridge having at least one circumferential beam extending radially therefrom with the beam having an axially projecting detent; mounting the bowl-cartridge combination on the head by rotating the bowl-cartridge combination less than 90° to engage connections between the filter bowl combination and the filter head until the detent snaps over a projection in the filter head; and while rotating, compressing a seal member on the filter cartridge to form a seal between and against the head and the filter cartridge.

In another aspect, a filter cartridge is provided comprising a treatment media construction and a connection system secured to the treatment media construction to allow for removable attachment of the filter cartridge to a receiving member, the connection system having a blocking piece to ensure proper engagement between the filter cartridge and the receiving member.

In preferred arrangements, the treatment media construction has a first end and an opposite second end, a first end construction is adjacent to the first end of the media construction, and the blocking piece extends radially outwardly from the first end construction.

In some examples, the blocking piece extends axially from the first end construction and in a direction away from the treatment media construction.

In some embodiments, the first end construction includes an outer radial wall and an axial wall covering the first end of the media construction, a plurality of ribs projecting radially from the outer radial wall of the first end construction with each of the ribs having a terminal end sized to engage a rim of a filter bowl when the cartridge is inserted into a filter bowl, and the blocking piece being circumferentially spaced adjacent to one of the ribs.

In another aspect, a bowl cartridge filter assembly is provided comprising the filter cartridge as characterized above and a bowl having an outer radial wall and an interior volume, the filter cartridge being removably mountable within the interior volume, the outer radial wall having a plurality of connecting sections alternating with non-connecting sections, and wherein when the filter cartridge is positioned within the bowl, the blocking piece is circumferentially adjacent to an end of one of the connecting sections.

In some embodiments, the bowl has an open mouth in communication with the interior volume defined by an end rim, the mouth having a plurality of recessed sections being the non-connecting sections of the bowl.

Some examples include a filter head removably attached to the bowl with the filter cartridge, the filter head having an inner radial surface including a plurality of circumferentially spaced sets of connecting segments constructed and arranged to mate with the connecting sections of the bowl, each connecting segment within each set being axially spaced from an adjacent connecting segment, wherein within each set, each connecting segment is axially spaced close enough to the adjacent connecting segment to block receipt of the blocking piece therebetween.

In another aspect, a filter assembly is provided comprising a first member and second member being removably connectable to each other, and the first member having a displaceable piece positioned on the first member to move from a blocking position to a clearance position when engaged with the second member and permit connection between the first member and second member.

In some arrangements, the displaceable piece comprises a pivotable pin positioned to pivot between the blocking position and the clearance position, and the second member includes a ramp positioned to push the pivotable pin from the blocking position to the clearance position.

In example embodiments, the first member comprises a filter head with an interior surface with the pivotable pin being attached to the interior surface of the filter head, the second member comprises a filter cartridge including a treatment media construction with a first end and opposite second end and having a first end construction adjacent to the first end of the media construction, wherein the first end construction includes the ramp.

In some arrangements, the ramp is along an outer periphery of the first end construction.

In another aspect, a method of mounting a filter assembly to a filter head is provided comprising: inserting a filter assembly into a filter head to displace a displaceable piece on the filter head; and rotating the filter assembly relative to the filter head to move the piece from a blocking position to a clearance position to permit connection between the filter assembly and the filter head.

In some example methods, the displaceable piece comprises a pivotable pin on the filter head positioned to pivot between the blocking position and the clearance position, and the step of rotating includes using a first end construction on the filter assembly to pivot the pin.

In example methods, the filter assembly includes a filter cartridge removably oriented within a filter bowl, and the step of rotating includes rotating the filter assembly less than 90° to engage connections between the filter bowl and the filter head.

According to the present disclosure, a variety of features and techniques are provided that can be implemented in liquid filter arrangements, such as a fuel filter arrangement, hydraulic filter arrangement or lubricant (oil) filter arrangements. Selected ones of the techniques can be applied in, preferably, spin-on filter arrangements or other arrangements.

Techniques described include features incorporated in one or both of the filter head and/or filter member removably mounted on the filter head.

There is no requirement that all of the techniques described herein be incorporated in a given system, for that system to obtain at least some advantage.

### BRIEF DESCRIPTION OF THE DRAWINGS

FIG. 1 is a block diagram of an engine and a filter system, illustrating principles of this disclosure;

FIG. 2 is a perspective view of a filter system, including a filter removably attached to a filter head;

FIG. 3 is a cross-sectional view of the filter system of FIG. 2, the filter system including the filter head and a bowl-cartridge assembly removably attached thereto;

FIG. 4 is a front view of a bowl-cartridge assembly of FIG. 3, removed from the filter head, the bowl-cartridge assembly including a filter bowl holding a removable and replaceable filter cartridge;

FIG. 5 is an exploded perspective view of the bowl and filter cartridge of FIG. 4;

FIG. 6 is a top plan view of the filter cartridge of FIG. 4;

FIG. 7 is an enlarged perspective view of a part of the filter cartridge;

FIG. 8 is a perspective view of the filter head of FIG. 3;

FIG. 9 is another perspective view of the filter head of FIG. 3;

FIG. 10 is an enlarged perspective view of a portion of the bowl filter cartridge installed in the filter head;

FIG. 11 is another enlarged perspective view of a portion of the bowl filter cartridge installed in the filter head;

FIG. 12 is a schematic diagram illustrating steps of installation of the bowl-filter cartridge onto the filter head;

FIG. 13 is a perspective view of another embodiment of a filter cartridge usable as part of the system of FIG. 1;

FIG. 14 is a front view of the filter cartridge of FIG. 13;

FIG. 15 is a top view of the filter cartridge of FIG. 13;

FIG. 16 is a bottom view of the filter cartridge of FIG. 13;

FIG. 17 is an enlarged perspective view of a first end cap of the filter cartridge of FIG. 13;

FIG. 18 is an enlarged front view of a portion of the first end cap of FIG. 17;

FIG. 19 is a perspective view of a bowl usable with the filter cartridge of FIG. 13;

FIG. 20 is a front view of the bowl of FIG. 19;

FIG. 21 is an exploded perspective view of a bowl-cartridge assembly, including the bowl of FIG. 19 and filter cartridge of FIG. 13;

FIG. 22 is a perspective view of the bowl-cartridge assembly of FIG. 21;

FIG. 23 is a perspective view of a filter head usable with the bowl-cartridge assembly of FIG. 22;

FIG. 24 is another perspective view of the filter head of FIG. 23;

FIG. 25 is a top plan view of the filter head of FIG. 23;

FIG. 26 is an enlarged perspective view of a portion of the filter head of FIG. 23;

FIG. 27 is a top plan view of another embodiment of a bowl usable with the bowl-cartridge assembly of FIG. 22;

FIG. 28 is an enlarged perspective view of a portion of the filter bowl of FIG. 27;

FIG. 29 is a top plan view of another embodiment of a bowl usable with the bowl-cartridge assembly of FIG. 22; the bowl showing projections, protrusions, and a pivotable pin;

FIG. 30 is an enlarged perspective view of the pivotable pin of FIG. 29;

FIG. 31 is a cross-sectional view of an initial step of installing the bowl-cartridge assembly of FIG. 22 onto the filter head of FIG. 29;

FIG. 32 is a similar view as FIG. 31 during another step of installation;

FIG. 33 is another step of installation of the bowl-cartridge assembly of FIG. 22 onto the filter head of FIG. 29;

FIG. 34 is a cross-sectional view of the bowl-cartridge assembly of FIG. 22 fully installed on the filter head of FIG. 29;

FIG. 35 is a cross-sectional view of a step of removing the bowl-cartridge assembly from the filter head of FIG. 29;

FIG. 36 is a cross-sectional view of a step of attempting to connect the bowl of FIG. 19 to the filter head of FIG. 29, without the filter cartridge present;

FIG. 37 is a front view of the first end construction of FIG. 13, removed from the rest of the filter cartridge, and showing an embodiment of the flexural member displaced in one or both tangentially and axially; and

FIG. 38 is a perspective view of the first end construction of FIG. 37.

### DETAILED DESCRIPTION

### Overview

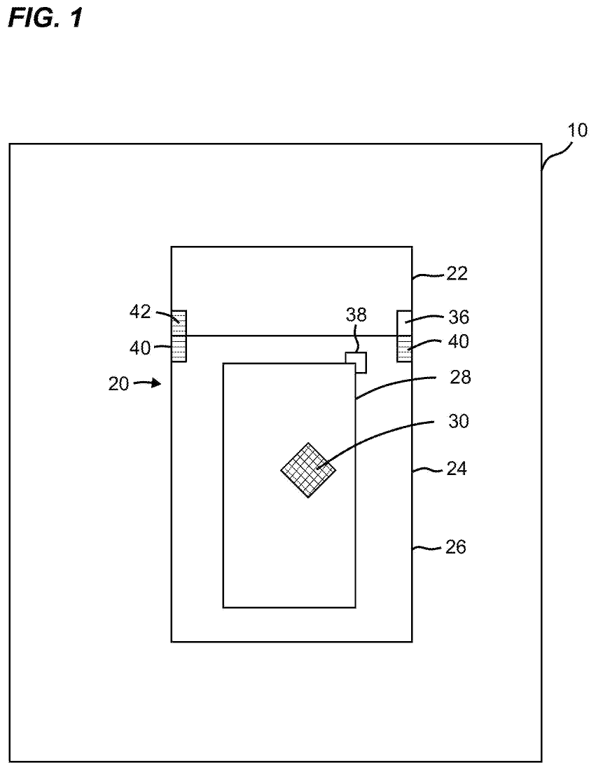

FIG. 1 is a schematic illustration of a system 10, which can be mobile or stationary systems. The system 10 can be an engine on a tractor or any equipment requiring fuel, lubrication, or having powered hydraulics. The system 10 uses a liquid filter assembly 20 for filtering fuel, lubrication fluid, or hydraulic fluid. The liquid filter assembly 20 includes a filter head 22 and a filter arrangement 24. The filter arrangement 24 is removably mountable on the filter head 22. The filter arrangement 24 may be a spin-on filter member (e.g., filter media non-removably secured within a shell or housing) or a bowl-cartridge assembly (a removable and replaceable filter cartridge held within a housing or bowl). In FIG. 1, the filter arrangement 24 includes a housing or bowl 26 holding filter media, which can be in the form of a filter cartridge 28.

In general, the filter cartridge 28 includes a treatment media construction 30, which may include various types of a filter media, including, e.g. cellulose, synthetic, fibrous, or combinations thereof. The media construction 30 may be pleated media, depth media, Z-media, or combinations. The media construction 30 can be in a tubular (e.g. cylindrical) configuration, or panel, or v-packs, or a diffuser cartridge, for example.

In some applications, after the filter arrangement 24 is attached to the filter head 22, operation of the system 10 can cause vibration, which might lead to the filter arrangement 24 becoming loose or detached from the filter head 22. In addition, internal system pressure may also cause the filter arrangement 24 to back off. In such conditions, it is advantageous for the filter cartridge 28 and filter head 22 to include structure that helps prevent relative motion between the cartridge 28 and the head 22, after being attached for operation.

In example arrangements, the filter arrangement 24 optionally includes a detent 32, which is engageable with a catch or projection 34 in the filter head 22 to prevent motion between the filter arrangement 24 and the filter head 22. In some examples, the detent 32 can be an integral part of the filter cartridge 28 and independent of the housing or bowl 26. In some examples, the media construction 30 has an outer perimeter, and the detent 32 is at or outside of the outer perimeter to prevent motion of the filter cartridge 28 relative to the head 22. By having the detent 32 at or outside of the outer perimeter, there is a longer moment arm and increased holding power, than if the detent 32 were inward of the outer perimeter. The interaction between the detent 32 and projection 34 can provide feedback, such as an audible “click” sound to inform the user that the filter arrangement 24 has been properly installed on the filter head 22.

Independent of above, the filter arrangement 24 optionally includes a connection system 36 secured to the treatment media construction 30 to allow for removable attachment of the filter cartridge 28 to a receiving member. The receiving member may include, for example, filter head 22. In one example arrangement, the connection system 36 has a blocking piece 38 to ensure proper engagement between the filter cartridge 28 and the filter head 22. For example, in systems that include threads, or not threads-but ridges or projections, it may be possible to cross-up the threads or ridges/projections and improperly align the connections between the filter cartridge 28 and filter head 22. The blocking piece 38 is useable to make sure the proper engagement is made, and the threads or ridges/projections are properly aligned.

Independent of above, the liquid filter assembly 20 may optionally include a first member and second member removable connectable to each other. For example, the first member can be the filter head 22, and the second member can be the filter arrangement 24. The first member, such as the filter head 22, has a displaceable piece 40 positioned theron to move from a blocking position to a clearance position when engaged with the second member (such as the filter arrangement 24) and permit connection between the first member and second member. This arrangement can lead to advantages. For example, if the second member (such as the filter arrangement 24) is not the proper second member to engage with the first member, the displaceable piece 40 will block engagement and prevent connection. In other examples, the filter arrangement 24 can include filter bowl 26 holding filter cartridge 28. If only the filter bowl 26 (without holding a filter cartridge 28) is oriented for connection with the filter head 22, the displaceable piece 40 will block engagement and prevent connection. On the other hand, if filter bowl 26 holding a correct filter cartridge 28 is oriented for connection with the filter head 22, the displaceable piece 40 will move from a blocking position and permit connection between the filter arrangement 24 and the filter head 22.

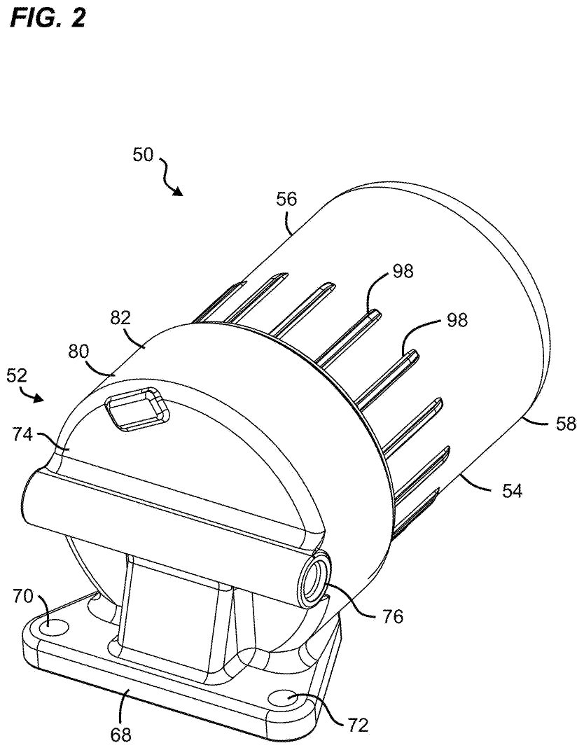

### Example Filter Assembly, FIGS. 2-5

In FIG. 2, reference numeral 50 generally indicates a liquid filter assembly according to the present disclosure. The liquid filter assembly 50 includes filter head 52 and filter arrangement 54. The filter head 52 is typically installed on equipment, in a liquid line, for example a fuel line, hydraulic line or lubricating fluid (oil) line. During servicing the filter head 52 would typically remain in place in the equipment.

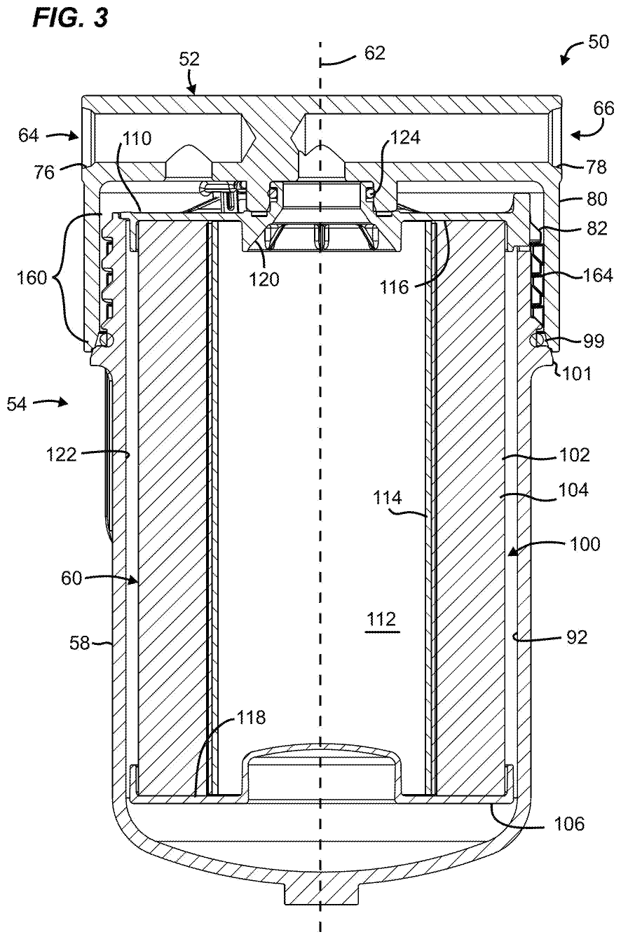

The filter arrangement 54, on the other hand, is removably mounted on the filter head 52. Servicing is provided by replacement of the media contained within the filter arrangement 54. The filter arrangement 54 depicted herein is a bowl-cartridge filter assembly 56, including an outer housing or bowl 58 and a removable and replaceable filter cartridge 60 (FIG. 3). During servicing, the filter arrangement 54 is removed from the filter head 52; the filter cartridge 60 is removed from the bowl 58 and discarded. An entirely new filter cartridge 60 is provided and inserted into the filter bowl 58 and then, the bowl-cartridge filter assembly 56 is again attached to the filter head 52. In an alternative arrangement, the bowl 58 is mounted and fixed, while the filter head is a removable cover.

In the cross section of FIG. 3, a central longitudinal axis 62 is depicted, around which the filter assembly 50 is positioned. The terms “axial”, “axially” and variants thereof, as used herein, is generally meant to refer to a feature extending in the general direction of the axis 62. The terms “radial”, “radially”, and variants thereof, are meant to refer to a direction toward or away from the axis 62.

Still in reference to FIG. 3, the filter head 52 includes a liquid flow inlet 64 and a liquid flow outlet 66. During operation, liquid to be filtered is directed into the filter head 52 through the inlet 64. Liquid is then directed through the filter arrangement 54 for filtration. The filtered liquid is then returned to the filter head 52 to exit through the outlet 66. In some systems, the flow can be reversed, such that the inlet 64 and outlet 66 are reversed (liquid flows into 66, through the filter arrangement 54, and then out through 64).

In a typical system, the filter head 52 comprises a cast metal part, for example, cast aluminum, with various features added thereto. The filter head 52 may also be plastic, made by a plastic injection molding process, for example.

While many embodiments are possible, in the one shown, the filter head 52 includes a flange 68 (FIG. 2), which can have bolt holes 70, 72 for securing the filter head 52 to the equipment.

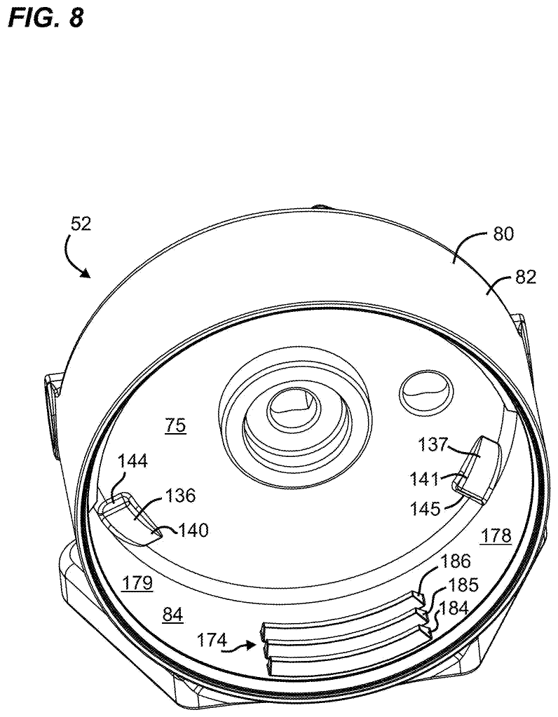

Secured to the flange 68 is an end wall 74. The end wall 74 will typically include an inlet opening 76 in communication with the inlet 64, to allow for the flow of liquid from the filter head 52 into the filter arrangement 54. End wall 74 will also have an outlet opening 78 to allow for the flow of filtered liquid from the filter arrangement 54 into the filter head 52 to allow it to exit through the outlet 66. The end wall 74 has an inner surface 75 (FIG. 8).

Extending axially from the end wall 74 is a surrounding wall 80 with an exterior surface 82 and an opposite interior or inner radial surface 84 (FIG. 8).

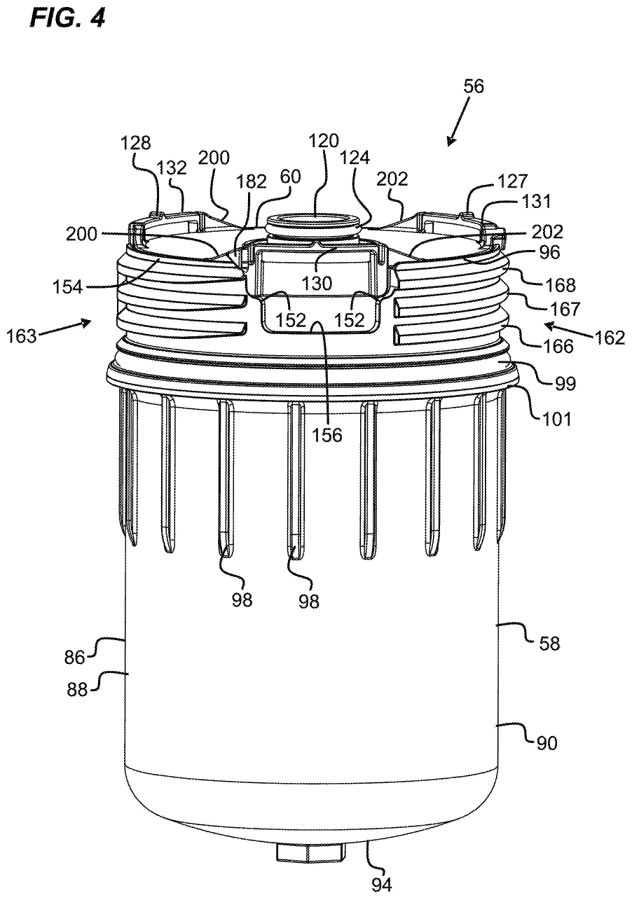

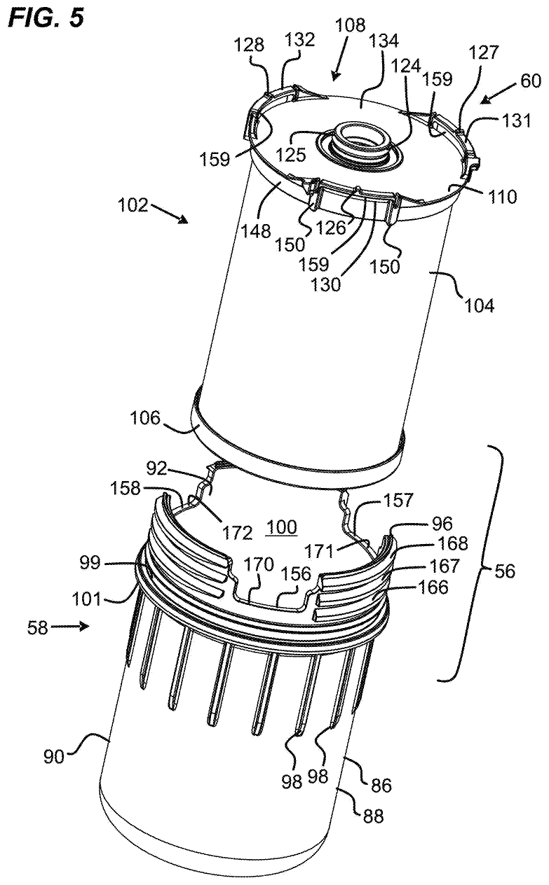

The bowl-cartridge filter assembly 56 is shown in perspective view in FIG. 4 and in exploded view in FIG. 5. The filter bowl 58 includes an external can or shell 86 that has a surrounding wall 88. The surrounding wall 88 has an exterior surface 90 and an opposite interior surface 92. There is a closed bottom 94 and an opposite mouth 96 that interfaces with the filter head 52.

The shell 86 can include a plurality of anti-slip ribs 98 circumferentially spaced about the shell 86 adjacent to the mouth 96. The ribs 98 can be helpful for the user to be able to apply a grip on the assembly 56, when attaching or removing the assembly 56 and the filter head 52.

The bowl 58 holds a seal member 99 to form a seal between the filter head 52 and the bowl 58 to prevent fluid leaking from the filter assembly 50 into the surrounding environment. In the example shown, the seal member 99 is against the exterior surface 90 of the wall 88 of the bowl 58. The seal member 99 is positioned just above and against a stop member 101 radially projecting from a remaining part of the wall 88 of the bowl 58. As explained below, there is a connection system 160, and the seal member 99 is between the stop member 101 and the connection system 160. The connection system 160 is immediately adjacent to the mouth 96 of the bowl 58, such that the connection system 160 is located axially between the mouth 96 and the seal member 99.

Typically, the outer shell 86 may be metal or plastic. The shell 86 defines an interior volume 100. Within the interior volume 100 is positioned the filter cartridge 60. The filter cartridge 60 comprises a treatment media construction 102 including filter media 104 positioned in extension between a second (lower) end cap 106 and a first (upper) end construction 108. The end construction 108 is adjacent to a first end of the media construction 102 and can be part of a first end cap 110 secured to the media construction 102. The media 104 can comprise a variety of materials as selected for the particular operation and conditions to be encountered. Typically, the filter media 104 would be provided in a pleated form, although alternatives are possible. A variety of types or shapes of media or media pleats can be used. Adhesive beads, for example, can help maintain media integrity and pleat spacing. In some alternative arrangements, the media 104 can be lined with a plastic or wire mesh screen, if desired.

Referring to FIG. 3, filter media construction 102 can be tubular in shape and configured around, and defines, an open filter interior volume 112. Positioned within the open filter interior volume 112 is an internal media support 114, in this example, comprising a porous liner extending along the media 104 between the end caps 106, 110 and secured to the end caps 106, 110.

Although alternatives are possible, in the example shown, the second end cap 106 is a closed end cap, meaning it has a closed center prohibiting passage therethrough of unfiltered liquid. The tubular filter media construction 102 has a first end 116, which is secured to the first end cap 110, and an opposite second end 118, which is secured to the second end cap 106. The media 104 is secured to the second end cap 106 by various methods, including adhering or potting, or by molding in place on the media 104. A variety of materials can be used for the end caps 106, 110, which can include metal or plastic.

The first end cap 110 is typically an open end cap defining a central flow aperture 120 therethrough. The aperture 120 is positioned in direct flow communication with the interior volume 112. Herein, the term “direct flow communication” is meant to refer to a passageway that allows a flow communication with the interior volume 112 in a manner that does not require passage through the media 104. That is, liquid within the interior volume 112 can flow through the aperture 120 directly, without passing through the media 104 at the same time. Of course, the liquid does not reach the interior volume 112 unless it has first passed through the media 104 in the first instance, for an “out-to-in” flow arrangement as described.

As indicated, the filter cartridge 60 depicted is configured for out-to-in flow, during filtering. By this, it is meant that unfiltered liquid is directed from the filter head 52 and into an annulus 122 between an outside of the media 104 and an interior surface 92 of the wall 88; and then through the media 104, through the support 114, and into the interior volume 112. The filtered liquid is then directed upwardly through central flow aperture 120 in the first end cap 110, back into the filter head 52 through the outlet opening 78 and then out through the outlet exit 66. In FIG. 3, it can be appreciated that there is a shared flow path in the space where the filter head 52 and the bowl 58 connect, and the flow path is open only when the connections 162-164 of the bowl 28 are properly seated. This leads to advantages, including reducing overall diameter and ensuring that the correct filter cartridge 28 is installed.

It is noted that many of the principles described herein can be utilized in association with a “in-to-out” flow arrangement, in which the flow direction for liquid being filtered is in the reverse direction, i.e., through the aperture 120, into the interior 112, through the media 104, into the annulus 122, and then back into the filter head 52.

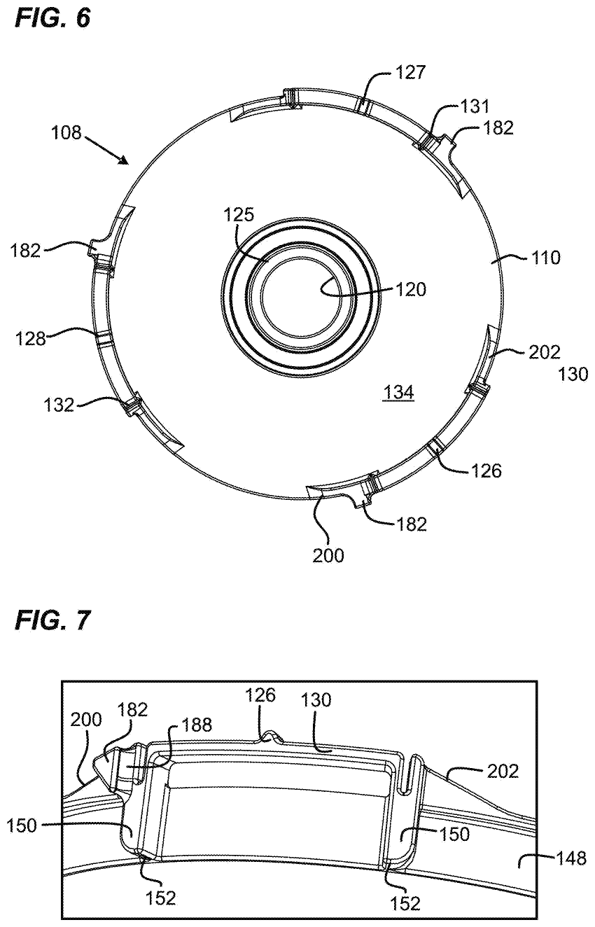

In general, a seal arrangement is needed between the filter cartridge 60 and the filter head 52 in order to prevent liquid flow from bypassing the media 104 as it is directed through the filter cartridge 60. Such a seal arrangement is provided by a seal member 124 on the cartridge 60 to form a seal between and against the cartridge 60 and the filter head 52. In the example shown, the first end construction 108 includes an open spigot 125 (FIGS. 5 and 6) projecting axially therefrom. The open spigot 125 provides communication with the open interior volume 112. The seal member 124 is a radially directed seal member on an outer wall of the spigot 125 to provide an outwardly directed radial seal with the filter head 52, when the filter cartridge 60 is attached to the filter head 52. In other embodiments, instead of a radial seal, there can be a face seal or axial seal member, positioned to form an axially directed seal with the filter head 52.

### Filter Cartridge 60 and Filter Head 52, FIGS. 5-8

In accordance with principles of this disclosure, the filter cartridge 60 can further include at least one spring-loaded detent 126. The detent 126 is at or outside of an outer perimeter of the treatment media construction 102, and it acts to prevent motion of the filter cartridge 60. In many preferred embodiments, and in the embodiment illustrated, there are a plurality of spring loaded detents 126, 127, 128, each extending at or outside of the outer perimeter of the treatment media construction 102. The spring loaded detents 126, 127, 128 are circumferentially spaced from one another and are preferably radially spaced outside of an outer perimeter of the first end cap 110.

Each spring loaded detent 126, 127, 128 is located on a beam 130, 131, 132 extending radially from an axial wall 134 of the first end cap 110. In the example embodiment shown, each detent 126, 127, 128 is centered on its respective beam 130, 131, 132. Each detent 126, 127, 128 projects axially from its supporting beam 130, 131, 132 and in direction away from the filter media 104.

The first end construction 108 includes an outer radial wall 148 and the axial wall 134. The axial wall 134 covers the first end 116 of the media 104. A plurality of ribs 150 project radially from the outer radial wall 148 of the first end construction 108. Each of the ribs 150 has a terminal end 152 positioned and sized to engage the filter bowl 58, when the cartridge 60 is inserted into the bowl 60.

In the example arrangement shown, each detent-supporting beam 130-132 extends between two of the ribs 150. The mouth 96 of the bowl 58 is defined by an end rim 154. As can be seen in FIGS. 4 and 5, the mouth 96 has a plurality of recessed sections 156, 157, 158. When the filter cartridge 60 is operatively positioned within the bowl 58, the terminal ends 152 of the ribs 150 engage against the rim 154, within the recessed sections 156-158 of the bowl 58. Each detent 126, 127, 128 is centered within a respective one of the recessed sections 156, 157, 158. Each beam 130, 131, 132 extends across a respective one of the recessed sections 156, 157, 158.

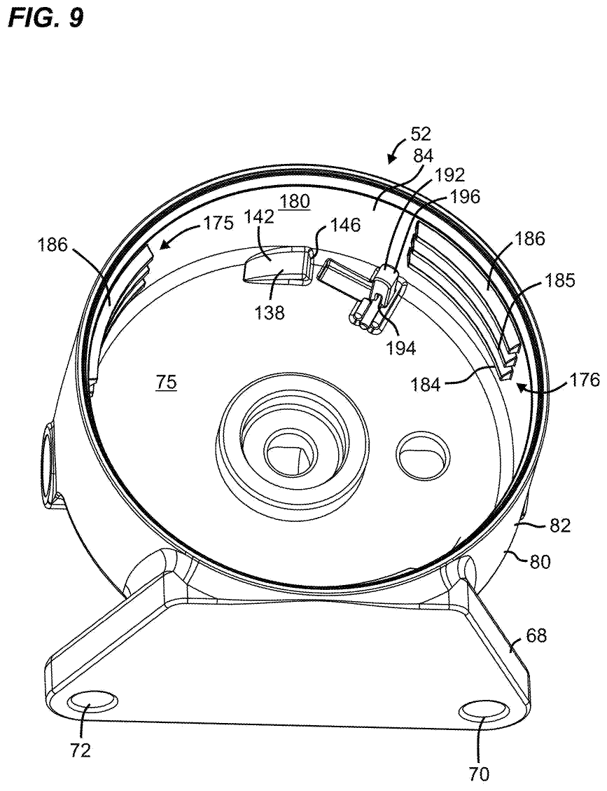

The detents 126, 127, 128 are received by projections 136, 137, 138 (FIGS. 8 and 9) defined within the inner surface 75 of the end wall 74 of the filter head 52. The interaction between the detents 126-128 and projections 136-138 provide feedback, such as an audible “click” sound to inform the user that the filter cartridge 60 has been properly installed on the filter head 52. The detents 126, 127, 128 also help to prevent the filter cartridge 60 from backing off of the filter head 52 due to vibration during operation, or due to internal system pressure. The feedback, in addition to being audible, can also be tactile, in that the user can also feel when the detents 126-128 are engaged with the projections 136-138. By having the detents 126-128 at or outside of the outer perimeter of the media construction 102, there is a longer moment arm and increased holding power, than if the detents 126-128 were inward of the outer perimeter.

In addition, having the beams 130-132 at or outside of the outer perimeter of the media construction 102 leads to manufacturing advantages. In example embodiments, no part or portion of each of the beams 130-132 is above (or projects axially away from) the axial surface 132 (top surface) of the first end cap 110; and no part of the axial surface 132 (top surface) of the first end cap 110 is below (or extends axially under) any portion of any of the beams 130-132. Because of this structure, manufacturing, including injection molding, for example, is more efficient, reliable, and cost effective, as compared to constructions in which these conditions are not met.

In FIGS. 8 and 9, the projections 136, 137, 138 are visible. The projections 136-138 are circumferentially spaced from each other on the inner surface 75 of the end wall 74 of the filter head 52. Each projection 136-138 is along the outer perimeter of the end wall 74 and next to the surrounding wall 80. Each projection 136, 137, 138 includes a sloped surface 140, 141, 142 to form a ramp-shape ending in a cliff or catch 144, 145, 146. In use, each detent 125-128 engages against and rides up the sloped surface 140-142, until snapping over the end cliff or catch 144-146.

In other embodiments, the detents 126-128 can be in the form of recesses into each respective beam 130-132, and the respective mating structure in the filter head 52 (e.g., projections 136-138) will be constructed and arranged to mate with the recesses on the beams 130-132. In still other embodiments, rather than beams, there can be cantilevered arms on the outer skirt 148 (radial side) of the end cap 110, engaging mating detent projections or structure on the inner sidewall 84 of the filter head 52.

When the filter cartridge 60 is installed in the bowl 58 and connected to the filter head 52, the inlet flow path includes the inlet liquid flowing under the beams 130-132 and into the annulus 122 between the inner surface 92 of the bowl 88 and the outer perimeter of the media 104. That is, the inlet flow travels through an opening 159 (FIG. 5) between the beam 130-132 and the axial wall 134 of the first end cap 110.

The above can be used in a method of installing the filter cartridge 60. The method comprises placing the filter cartridge 60 into the filter bowl 58 to provide a bowl-cartridge combination or assembly 56. The cartridge 60 has at least one circumferential beam 130-132 extending radially therefrom; each of the beams 130-132 having axially projecting detent 126-128. Next, mounting the bowl-cartridge combination 56 on the head 52 by rotating the bowl-cartridge combination 56 less than 90° to engage connections between the filter bowl combination 56 and the filter head 52, until the detent 125-128 snaps over one of the projections 136-138 in the filter head 52. While rotating, the method includes compressing seal member 124 on the filter cartridge 60 to form a seal between and against the head 52 and the filter cartridge 60. The method also includes compressing seal member 99 on the bowl 58 between and against the inner surface 84 of the wall 80 of the filter head 52 and the exterior surface 90 of the wall 88 of the bowl 58.

In accordance with principles of this disclosure, the filter cartridge 60 includes a system to allow for a low friction installation of the filter arrangement 54 to the filter head 52 and results in a reliable seal compression, including simply inserting and rotating the filter arrangement 54 less than a full turn. In this embodiment, the system includes a connection system 160 (FIG. 3). The connection system 160 will allow for low friction insertion and turning of the cartridge 60 less than 180° for example, about 60° and result in a reliable seal compression. The connection system 160 eliminates cross-threading, and lends itself to having the connectors be specific to specific customers.

In the example embodiment illustrated in FIGS. 4 and 5, the connection system 160 includes a plurality of circumferentially spaced connecting sections, illustrated herein as 162, 163, and 164 (FIG. 3) located on the filter assembly 56, and in the example shown, the bowl 58. In alternatives, the plurality of connecting sections may be, instead, a single connection section, such as a screw thread. Each connecting section 162, 163, 164 can include screw threads, or preferably and as shown in the drawings, a plurality of helical profiles 166, 167, 168. The connection sections 166, 167, 168 may be identical, or may be unique, including differences in thickness or height to accommodate different stress loads. For some embodiments there may be an advantage in having only one alignment position. The number of aligning positions depends on the number of connecting sections, and whether they are unique or identical.

Each of the helical profiles 166, 167, 168 extends circumferentially along and projecting from the outer radial wall 88 of the bowl 58. By “helical profile”, it is meant the geometrical outline along an outermost border which, if continued, would have a general spiral shape. Although in some embodiments, screw threads can be used, a helical profile is not a screw thread. In a helical profile, a plane perpendicular to the central longitudinal axis will pass through more than one profile, whereas in a screw thread, a plane perpendicular to the central longitudinal axis will pass through only one thread profile.

Preferably, each connecting section 162, 163, 164 is identical to the other connecting sections 162, 163, 164. This means that when mounting the bowl-cartridge assembly 56 onto the filter head 52, the user does not have to be concerned about matching the correct connecting section 162, 163, 164 with the particular receiving connecting segments on the filter head 52.

Preferably, the outer radial wall 88 has a plurality of alternating circumferentially spaced connecting sections 162, 163, 164 and alternating non-connecting sections 170, 171, 172. In the example shown, the recessed sections 156, 157, 158 form the non-connecting sections 170, 171, 172.

In reference now to FIGS. 8 and 9, the filter head 52 is shown in further detail. The inner radial surface 84 of the filter head 52 includes a plurality of circumferentially spaced sets 174, 175, 176 of connecting segments 184, 185, 186 constructed and arranged to mate with the connecting sections 162, 163, 164 of the bowl-cartridge assembly 56. The connecting sets 174, 175, 176 are circumferentially spaced along the inner radial surface 84 and are separated by smooth, ungrooved, portions 178, 179, 180 of the inner radial surface 84.

In accordance with principles of this disclosure, the connection system 160 includes a blocking piece 182 to ensure proper engagement between the filter cartridge 60 and filter head 52. Attention is directed to FIGS. 4 and 7. In this example embodiment, the blocking piece 182 extends axially from the first end construction 108 and in a direction away from the treatment media construction 102. The blocking piece 182 is circumferentially spaced adjacent to one of the ribs 150 on the outer radial wall 148 of the first end construction 108. When the filter cartridge 60 is positioned within the bowl 58, the blocking piece 182 is just above the rim 154 of the bowl 58 and immediately adjacent to the recessed sections 156-158. The blocking piece 182 is also circumferentially adjacent to an end of one of the connecting sections 162-164.

The blocking piece 182 can be made in many different configurations. In the example shown in FIG. 7, the blocking piece 182 is triangle-shaped, and oriented so that one of the sides 188 faces the segments 184-186 of the sets 174-176 of segments 184-186. The length of the side 188 is larger than the spacing between each segment 184, 185, 186. In alternatives, the blocking piece 182 can be the connecting sections 162-164 themselves, if designed to have different pitches or thicknesses, etc.

In reference again to FIGS. 8 and 9, each connecting segment 184, 185, 186 within each set 174, 175, 176 are axially spaced from an adjacent connecting segment 184, 185, 186. Within each set 174, 175, 176, each connecting segment 184, 185, 186 is axially spaced close enough to the adjacent connecting segment 184, 185, 186 to block receipt of the blocking piece 182 therebetween. This ensures that the profiles 166-168 are properly aligned with the segments 184-186. In alternatives, the spacing between the connecting segments 184-186 can be varied to result in a single, clocked insert position of the bowl-cartridge assembly 56, which can be useful in selected situations.

The above can be used in a method of connecting filter cartridge 60 to filter head 52. The method includes putting the filter cartridge 60 into the filter bowl 58, the filter bowl having connecting sections 162-164 to result in bowl-cartridge assembly or combination 56. The filter cartridge 60 has blocking piece 182 projecting from the filter bowl 58. Next, there is the step of inserting the bowl-cartridge combination 56 into the filter head 52. The filter head 52 has the circumferentially spaced sets 174-176 of connecting segments 184-186 constructed and arranged to mate with the connecting sections 162-164 of the bowl 58. Next, the method includes using the blocking piece 182 to ensure that the connecting segments 184-186 and connecting sections 162-164 are operatively aligned. The step of using the blocking piece 182 includes aligning the connecting segments 184-186 and connecting sections 162-164 to allow the bowl-cartridge combination 56 to rotate relative to the filter head 52.

Some methods further include rotating the bowl-cartridge combination 56 less than 90° to engage the connecting segments 184-186 and connecting sections 162-164 until the detent 126-128 snaps over projection 136-138 in the filter head 52.

### No Filter, No Run; FIGS. 9-12

In general, in accordance with principles of this disclosure, there is provided system to make sure that if the wrong or incomplete filter is attempted to be attached to the filter head, it will not work-it will be inoperable. In general, one of the filter head or filter arrangement (assembly) has a displaceable piece; the displaceable piece being positioned to move from a blocking position to a clearance position when engaged with the other of the filter head or filter arrangement (assembly) and permit connection therebetween.

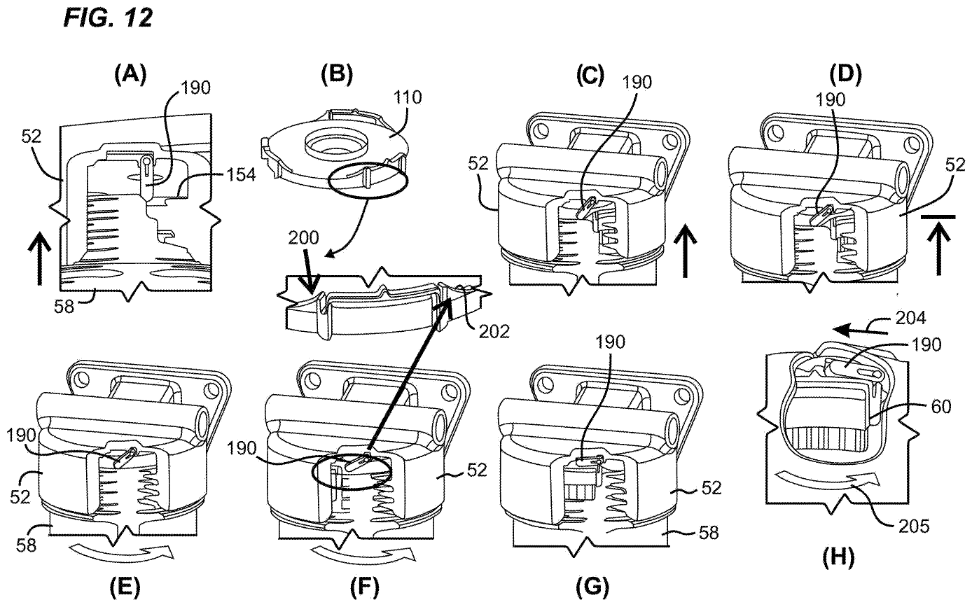

Attention is first directed to the schematic diagram of FIG. 12. Diagram A shows filter head 52 and filter bowl 58, without a filter cartridge 60 in the bowl 58. The bowl 68 and head 52 are blocked from connecting to each other. In Diagram A, a displaceable piece 190 interferes with the rim 154 of the bowl 58 and stops vertical movement therebetween, preventing connection between the bowl 58 and head 52. The up arrow in Diagram A shows the vertical motion of the bowl 58 into the head 52. Diagrams B-H show steps of properly connecting the bowl-cartridge filter assembly 56 with the head 52, when the proper filter cartridge 60 is correctly oriented in the proper bowl 58. Diagrams B-H will be referred to further, below.

In this embodiment, the filter head 52 includes displaceable piece 190 in the form of a pivotable pin 192. In FIG. 9, the pin 192 is shown extending upright from the inner surface 75 of the end wall 74. The pin 192 is generally rectangularly shaped and, when upright, extends partially (not fully) along the inner surface 84 of the wall 80. The pin 192 is located along the outermost periphery of the end wall 74.

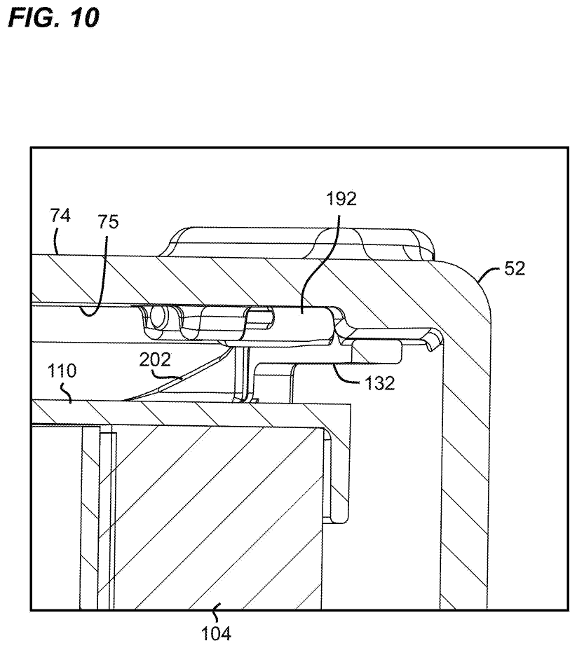

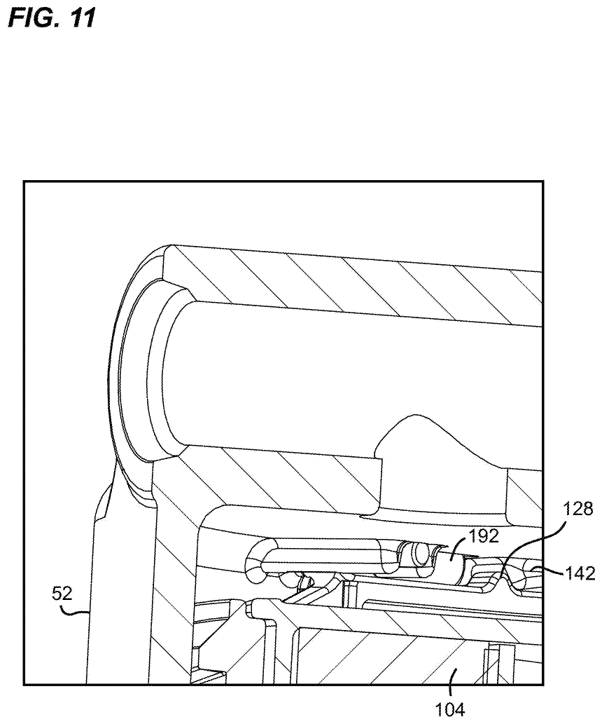

The pin 192 has a pivot (or hinge) point 194 next to the inner surface 75 of the end wall 74. The pivot point 194 allows the pin 192 to pivot 90 degrees from the upright position shown in FIG. 9 to a down position, shown in FIG. 10, and also from the down position (FIG. 10) to the upright position (FIG. 9). The down position includes the pin 192 lying against the inner surface 75 of the end wall 74. That is, the pin 192 has a free end 196, and the free end 196 moves from being spaced away from the inner surface 75 of the end wall 74 to adjacent to the inner surface 75 of the end wall 74. In use, the upright position of FIG. 9 and Diagram A in FIG. 12 is a blocking position, preventing connecting with the filter head 52. The down position of FIG. 10 and Diagram (H) in FIG. 12 is a clearance position, allowing connecting with the filter head 52.

In reference now to FIGS. 4 and 7, the filter cartridge 60 includes structure to move the displaceable pin 192 from the blocking position to the clearance position. In general, the filter cartridge 60 does this using a ramp. As embodied herein, the first end construction 108 includes at least a first ramp 200. The first ramp 200 extends from the axial wall 134 of the first end cap 110 at the peripheral edge and ramps up to the beams 130-132. The first ramp 200 pushes on the pin 192 to pivot it about the pivot point 194 and move it from the blocking position. See diagram B of FIG. 12.

The filter cartridge 60 further includes a second ramp 202. The second ramp 202 extends from the axial wall 134 of the first end cap 110 at the peripheral edge and ramps up to the beams 130-132, on an opposite side of the beams 130-132 from the first ramp 200. As such, the beams 130-132 are between the first ramp 200 and second ramp 202. The second ramp 202 guides the pin 192 up to the clearance position, as the filter assembly 56 is rotated into connection with the filter head 52. See Diagram F in FIG. 12.

As can be appreciated from the above, in this embodiment, there are two stages of pin 192 displacement. The first stage of pin 192 displacement is achieved through relative axial motion of the first ramp 200 interfacing with the pin 192. The second stage of pin 192 displacement is achieved through relative radial motion of the second ramp 202 interfacing with the pin 192.

In reference again to FIG. 12, the method of mounting filter assembly 56 on the filter head 52 is shown. The filter assembly 56 is inserted into filter head 52 to displace the displaceable pin 192 on the filter head 52. The first ramp 200 engages the pin 192 to pivot it from vertical to begin pivoting through 90 degrees. See B, C, and D. In E and F, the filter assembly 56 is rotated, and while rotating, the second ramp 202 continues to guide the pin 192 to the clearance position of FIG. 9. Diagram G shows the fully installed position of the filter head 52 connected to the filter assembly 56. Diagram H illustrates how the pin 192 pivots in a direction opposite of the rotation direction of the filter assembly 56, with the arrow 204 showing the pivot direction of the pin 192 and the arrow 205 showing the rotation direction of the filter assembly 56.

Preferably, the step of rotating the filter assembly 56 includes rotating the filter assembly less than 90° to engage connections between the filter bowl 58 and the filter head 52.

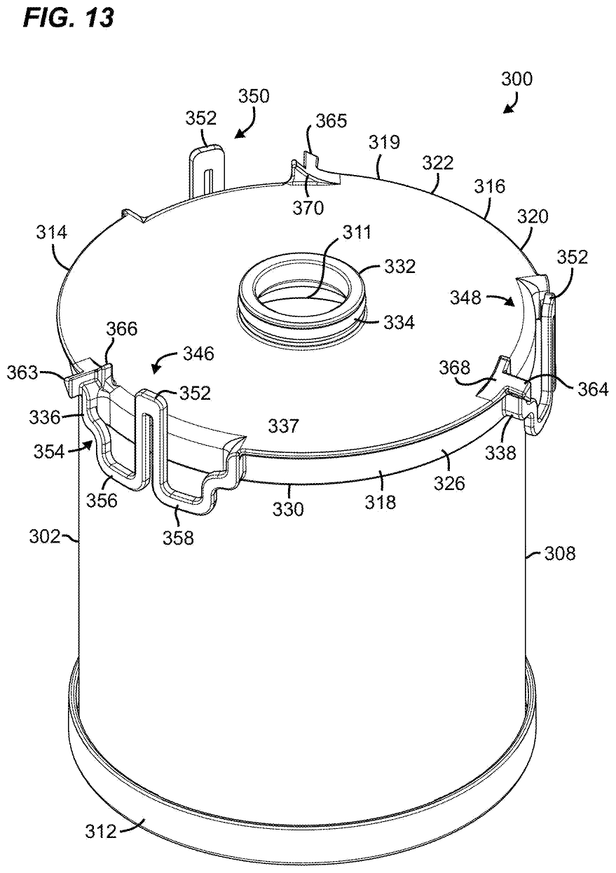

### Filter Cartridge of FIGS. 13-18

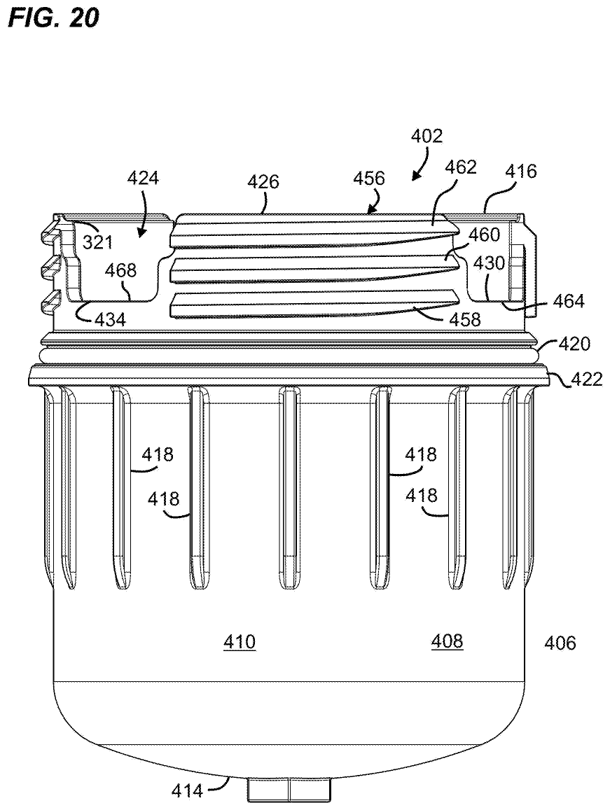

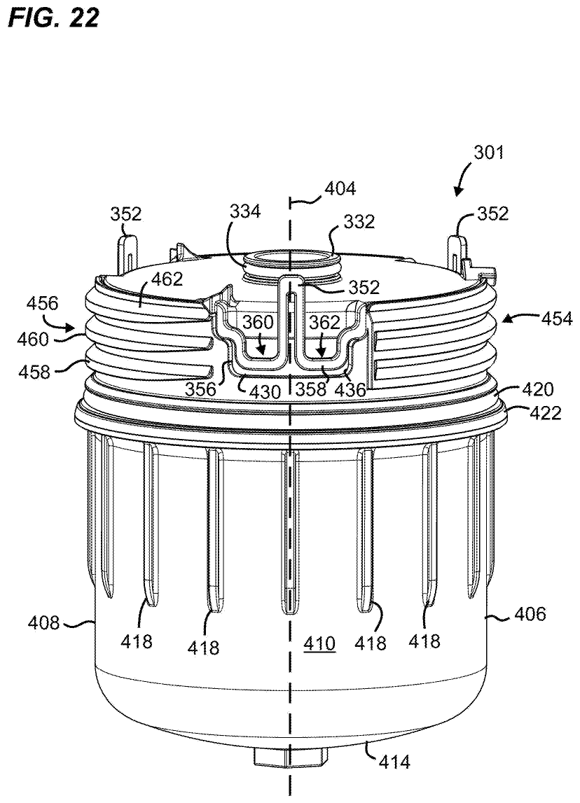

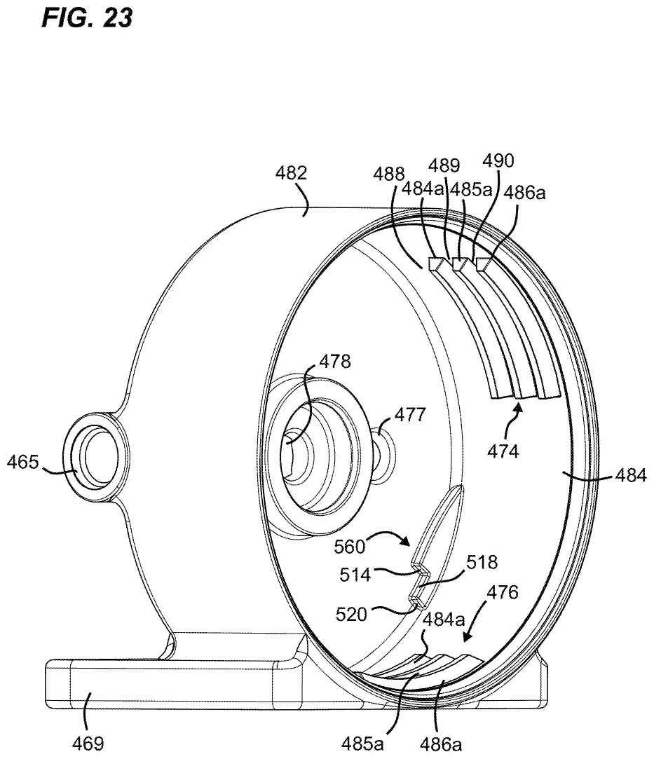

In FIGS. 13-18, another embodiment of a filter cartridge is illustrated and generally designated by reference numeral 300. The filter cartridge 300 is usable as part of the system 10 of FIG. 1 and is removably connectable to a filter head, such as filter head 400 (FIGS. 23-36). The filter cartridge 300 shares some common features with the filter cartridge 60 described above, but includes some structural differences, as described below. The filter cartridge 300 can be part of a bowl-cartridge filter assembly 301 (FIG. 22), in which the filter cartridge 300 is removably positionable in a filter bowl 402 (FIGS. 19-22).

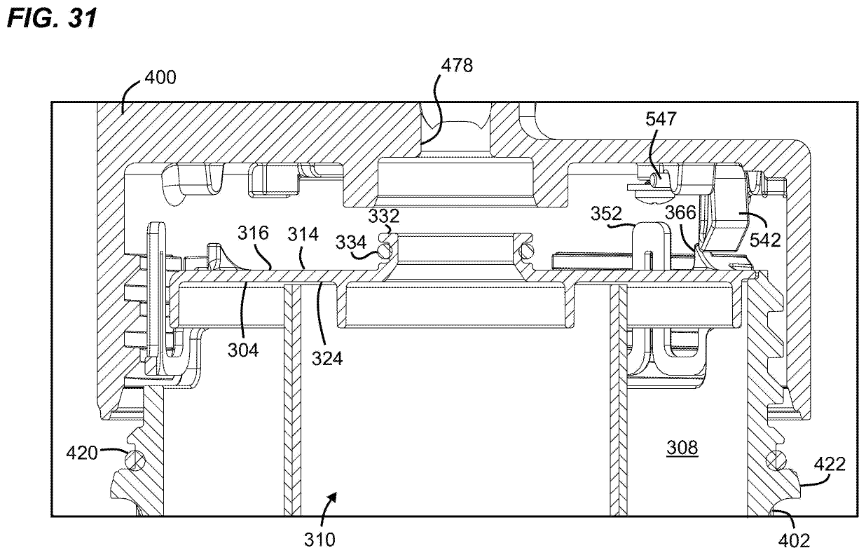

The filter cartridge 300 comprises a treatment media construction 302 having a first end 304 and an opposite second end 306. In an example, the media construction 302 comprises a tubular, such as a cylindrical construction, of pleated filter media 308 defining an open interior volume 310 (FIG. 31).

The filter media 308 may include a variety of materials as selected for the particular operation and conditions to be encountered, and can include cellulose, synthetic, fibrous materials, or combinations thereof. In the example shown, the filter media 308 is provided in a pleated form, although alternatives are possible.

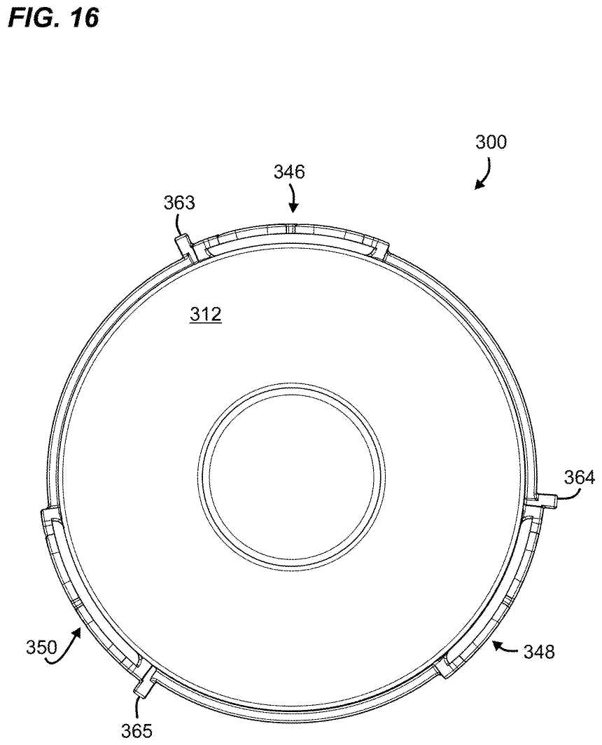

A second end construction 312 (FIG. 16) is secured to the second end 306 of the media construction 302. The second end construction 312 can be in the form of a closed end cap, meaning it has a closed center prohibiting passage therethrough of unfiltered liquid. The media 308 is secured to the second end construction 312 by various methods, including adhering, potting, or by molding in place on the media 308.

A first end construction 314 is adjacent to the first end 304 of the media construction 302 and is secured thereto. The first end construction 314 can be secured to the media construction 302 with potting material, glue, or it may be directly molded thereon.

The first end construction 314 can be part of a first end cap 316. The first end construction 314 has an outer periphery 318 and includes an axial portion 320 having an exterior surface 322 and an opposite interior surface 324 (FIG. 31). A circumferential skirt 326 extends from the interior surface 324 of the axial portion 320. The circumferential skirt 326 forms the outer periphery 318 of the first end construction 314 and extends axially away from the axial portion 320 in a direction toward the second end construction 312. The skirt 326 surrounds, or circumscribes, the filter media 308. The circumferential skirt 326 includes a free-edge rim 330 at its distal end, opposite from the axial portion 320.

The first end construction 314 further includes a circumferential projecting lip arrangement 328 positioned between the axial portion 320 and the circumferential skirt 326. The lip arrangement 328 projects radially outwardly from the circumferential skirt 326 and the axial portion 320. The lip arrangement 328 can be considered an outer rim 319 of the first end construction 314. The lip arrangement 328 rests against an inner ledge 321 (FIG. 19) of a filter bowl 402 (FIG. 19), when the filter cartridge 300 is positioned within the filter bowl 402. Alternatively, the lip arrangement 328 may rest against an end rim 426 of the bowl 402. The lip arrangement 328 prevents downward axial motion between the cartridge 300 and the bowl 402. The lip arrangement 328 may be circumferentially continuous as a plurality of lip sections 328a, or they may be include several shorter sections. There are also a plurality of non-lip sections 328b. In the example shown, the non-lip sections 328b circumferentially alternate with the lip sections 328a. Each of the lip sections 328a projects radially outwardly from the circumferential skirt 326 and the axial portion 320. The non-lip sections 328b are between ribs 336 of each rib pair 336, 337; 338, 339, 340, 341, as explained further below.

The first end construction 314 includes an opening 311 providing communication with the open interior volume 310, allowing fluid flow between the interior volume 310 (FIG. 31) and an exterior of the filter cartridge 300. In the example embodiment shown, there is an open spigot 332 defining the opening 311. The open spigot 332 projects axially from the first end construction. The open spigot 332 extends an axial distance away from the exterior surface 322 of the axial portion 320.

The first end construction 314 holds a seal member 334 to form a seal between the filter cartridge 300 and filter head 400 when the filter cartridge 300 is attached to the filter head. There are many options for the location of the seal member 334. In the example embodiment illustrated, the seal member 334 is mounted on the spigot 332 and forms a radial seal. In other embodiments, the seal member 334 can be one of: an axial seal, an inner radial seal, an outwardly directed radial seal, or a grommet. In the example shown, the seal member 334 is an outwardly directed radial seal member positioned on an outer wall of the spigot 332 to provide an outwardly directed radial seal with the filter head 400, when the filter cartridge 300 is attached to the filter head 400.

In accordance with principles of this disclosure, the filter cartridge 300 includes a plurality of extensions, tabs, or ribs 336 projecting radially from the circumferential skirt 326 of the first end construction 314 sized to engage a rim 317 of filter bowl 402 (FIG. 19), when the cartridge 300 is inserted into the filter bowl 402 (FIG. 22). The ribs 336, illustrated herein, are longitudinally directed and circumferentially spaced from each other along the skirt 326. The ribs 336 resist circumferential motion (force) within the bowl 402. In this embodiment, there are 3 rib pairs. By “rib pairs”, it is meant two ribs forming a pair that are more closely located to each other than to other ribs in the rib pairs. For example, in this embodiment and in reference to FIGS. 13, 14, 17, and 18, the first rib pair is shown at 336, 337; the second rib pair is shown at 338, 339; and the third rib pair is shown at 340, 341. Between the ribs 336 of each rib pair 336, 337; 338, 339, 340, 341 is one of the non-lip sections 328b.

In accordance with principles of this disclosure, the filter cartridge 300 includes a feedback mechanism to communicate whether the cartridge is attaching to the filter head 400. In the example shown, the feedback mechanism is a click device 344. The click device 344 is constructed and arranged (configured) to produce sound, or a noise, or an audible click of at least 40-80 dBA, while the filter cartridge 300 is connecting to filter head 400. The audible click provides feedback to the user that the filter cartridge 300 has been properly installed on the filter head 400.

In the example embodiment shown, the click device 344 is attached to the first end construction 314. Many embodiments are possible. In one example, the click device 344 comprises a flexural member 346. By “flexural”, it is meant the member 346 is designed to experience both compression and tension. The flexural member 346 is elastically deformable, meaning that it undergoes temporary, reversible changes in shape or size under applied stress, and returns entirely to its original dimensions once the load is removed.

In example embodiments, the flexural member 346 is located along the outer periphery 318 of the first end construction 314. By “along” the outer periphery 318, it is meant that the flexural member 346 can be any one of tangential to the outer periphery 318, directly attached to the outer periphery 318, or adjacent to the outer periphery 318. “Adjacent to” the outer periphery 318 can mean near to, but spaced (radially and/or axially) from it.

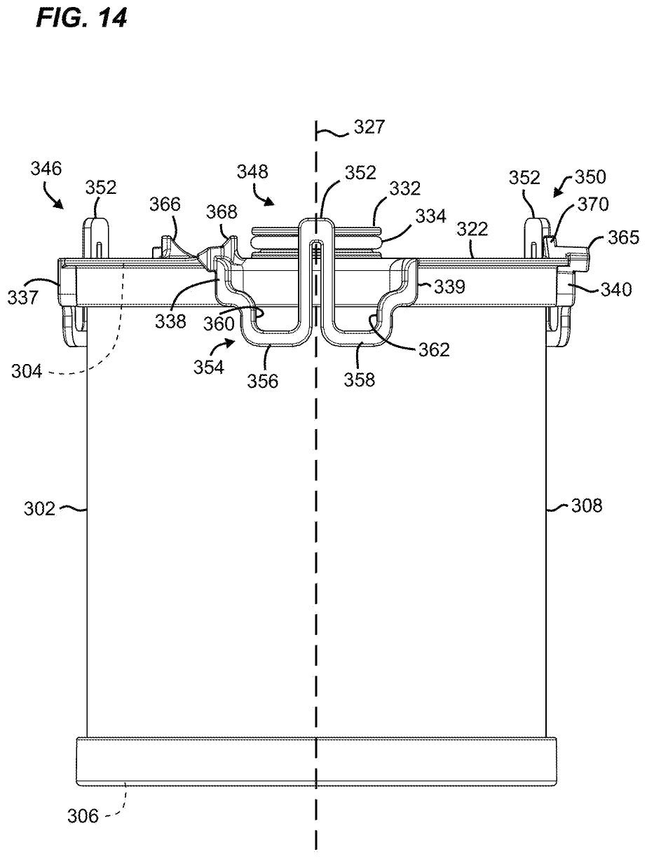

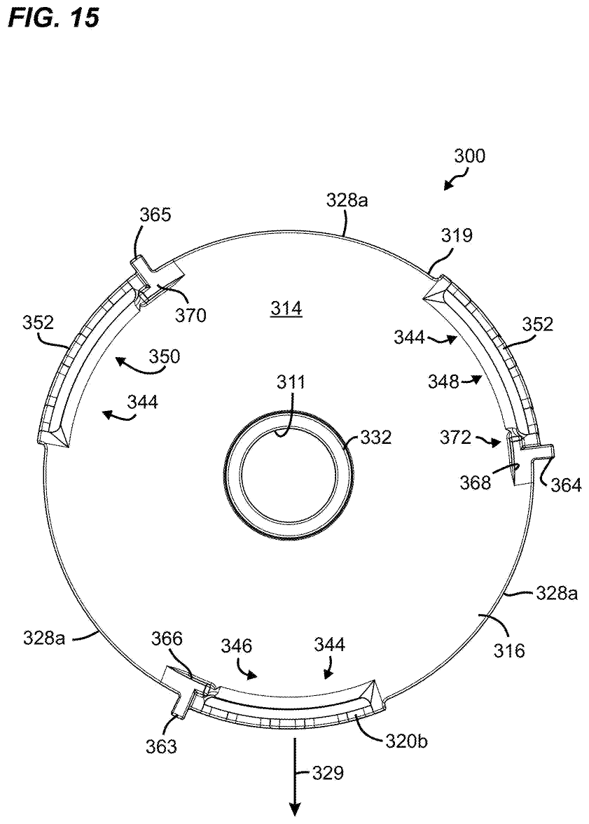

In preferred embodiments, the flexural member 346 is radially deflectable. By “radially deflectable”, it is meant the flexural member 346 is elastically deformable or displaceable in a direction perpendicular to a central longitudinal axis 327 (FIG. 14) of the filter cartridge 300 when subjected to an external load. The radial deflection may be either or both an inward radial deflection or an outward radial deflection. See the arrow 329 in FIG. 15 showing an example of outward radial deflection.

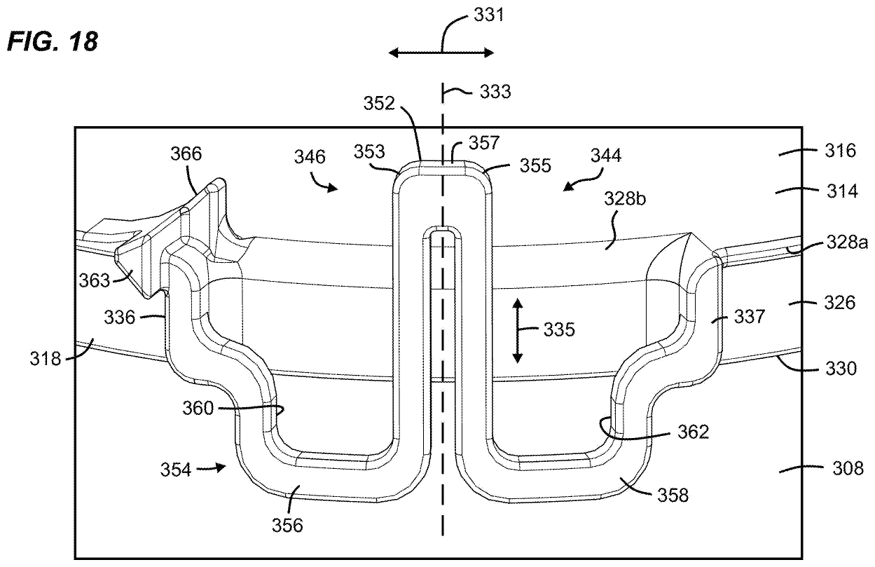

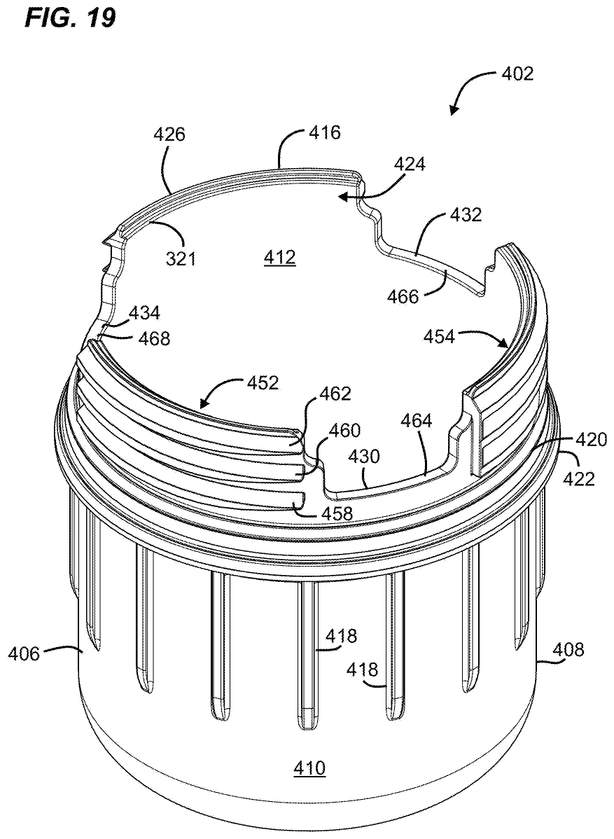

Preferably, the flexural member 346 is at least one of (or both of): tangentially deflectable or axially deflectable. By “tangentially deflectable”, it is meant that the flexural member 346 can elastically bend or shift along a path that is tangent to the outer periphery 318 of the round shaped first end construction 314. See the arrow 331 in FIG. 18 for an example of the direction of “tangential deflection.” By “axially deflectable”, it is meant that the flexural member 346 can elastically move (displace) along its own central, longitudinal axis 333 (FIG. 18) to change in length, such as shorten when under compression, for example. See the arrow 335 (FIG. 18) for an example of the direction of “axial deflection.”

In preferred embodiments, the flexural member 346 is radially deflectable, tangentially deflectable, and axially deflectable. The flexural member 346 can be radially inwardly flexible or radially outwardly flexible. In example arrangements, the flexural member 346 is constructed and arranged such that to displace the flexural member 346 radially by 1.2 mm at the interface member 352 requires a force of 0.3 lbs to 10 lbs; in some examples, 0.5 lbs to 5 lbs; in some examples, 0.6lbs to 2 lbs; and in some examples, 1-2 lbs. One way to test the radial flexibility of the flexural member 346 is to apply a load to the interface member 352 about 2 mm down from its free terminal end 357 (FIG. 18) using an electronic compression tester, such as one from Larson Systems, ECT-110, SN 6874022321. The displacement of 1.2 mm is fixed, and the amount of force needed to achieve that much displacement is measured using the compression tester.

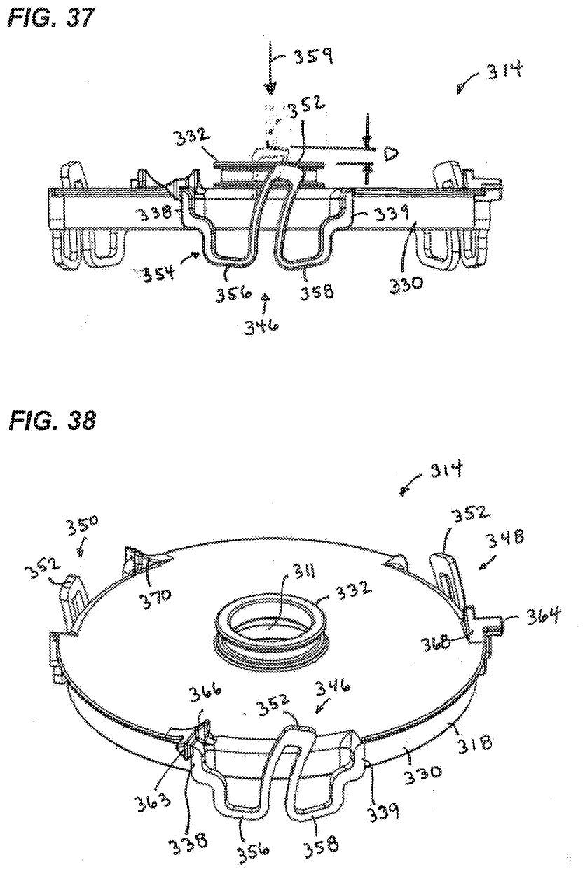

The flexural member 346 is constructed and arranged such that to displace the interface member 352 in a direction toward the treatment media construction 302 by 2 mm requires a force of between 0.2-15 pounds. FIGS. 37 and 38 show the first end construction 314 with the flexural member 346 displaced in a direction (arrow 359, FIG. 37) toward the treatment media construction 302 by a distance of 2 mm, shown at dimension D in FIG. 37. For simplicity, FIGS. 37 and 38 do not show the rest of the filter cartridge 300. In FIGS. 37 and 38, the displacement of the flexural member 346 toward the treatment media construction 302 can include one or both tangential and axial directional components, and the total displacement in the axial direction is 2 mm. This can be tested using an electronic compression tester, such as one from Larson Systems, ECT-110, SN 6874022321. The displacement of 2 mm is fixed, and the amount of force needed to achieve that much displacement is measured using the compression tester by attaching the load to the interface member 352 and measuring the amount of force needed for the 2 mm axial displacement. The amount of force needed, in general, ranges between 0.2-15 lbs; for example, 0.5-7 lbs.; for example 0.7-5 lbs; and for example 1-3 lbs.

In the example embodiment illustrated, there are a plurality of flexural members 346, 348, 350 circumferentially spaced along the outer periphery 318 of the first end construction 314. For example, there can be two, three, four, or more flexural members 346. In the example shown, there are three flexural members 346, 348, 350.

Each of the flexural members 346, 348, 350 is positioned between one of the rib pairs. For example, flexural member 346 is located between ribs 336 and 337; flexural member 348 is positioned between ribs 338 and 339; and flexural member 350 is positioned between ribs 340, 341.

The flexural member 346, 348, 350 is designed to exhibit bending behaviors in different directions to optimize both installation functionality and operational performance. The flexural member 346, 348, 350 provides controlled flexibility in a radial direction while maintaining sufficient stiffness in a tangential direction to resist unwanted rotation during operation.

In accordance with principles of this disclosure, the flexural member 346, 348, 350 exhibits a primary flexural mode in the radial direction. When subjected to radially directed forces during installation, at least part of, and in some cases, most or all of, the flexural member 346, 348, 350 undergoes elastic deformation. This radial bending stores elastic strain energy within the flexural member 346, 348, 350. As the filter cartridge 300 rotates into its final installed position relative to the filter head 400, the stored elastic energy is released to allow part of the flexural member when the interface member 352 snaps over structure in the filter head 400, producing an audible click. The radial flexibility is designed to minimize installation forces required by an end user while ensuring reliable engagement with the filter head 400.

The flexural member 346, 348, 350 also includes an anti-rotation mode in the tangential direction. When subjected to tangentially directed forces, shorter segments of the flexural member 346, 348, 350 undergo bending, resulting in greater stiffness compared to the radial direction. This tangential stiffness provides resistance to rotational forces that could otherwise cause the filter cartridge 300 to loosen from the filter head 400 during operation due to vibration or system pressure variations.

The bending behaviors of the flexural member 346, 348, 350 are achieved through at least three factors: (1) overall geometry of the flexural member 346, 348, 350, (2) cross-sectional area moment of inertia properties, and (3) flexural modulus of the material.

The overall geometry of the flexural member 346, 348, 350 determines the effective bending span in each direction. The radial direction uses a longer effective bending span, providing greater flexibility, while the tangential direction utilizes shorter bending segments, providing greater stiffness.

The cross-sectional area moment of inertia is selected to achieve the desired flexibility ranges. The material selection for the flexural member 346, 348, 350, having a Flexural modulus of 1-10 GPa per ASTM D790, provides bending stiffness and elastic energy storage capacity required for reliable click generation and long-term durability under repeated installation and removal cycles.

Given these factors, the flexural member 346, 348, 350 may have several different embodiments that accomplish the design principles. In the embodiment depicted herein, each flexural member 346, 348, 350 includes an interface member 352. By “interface member” it is meant the member or feature or piece that engages in physical contact with the filter head 400. The interface member 352 may have many embodiments. In the non-limiting example shown in FIG. 18, the interface member 352, generally has a rectangular front and rear face with rounded corners 353, 355 between a generally flat end surface 357. Many embodiments are possible.

The interface member 352 can be supported by an arm arrangement 354. Many embodiments are possible. In the example shown, each arm arrangement 354 includes a first hook shaped arm 356 and a second hook shaped arm 358 with the respective interface member 352 therebetween. In the example shown, the flexural members 346, 348, 350 are symmetrical, with a plane of symmetry passing through the interface member 352, but in other embodiments, it need not be symmetrical. While many embodiments are possible, the one depicted in FIG. 18 is eye-catching and attractive, in addition to being distinctive in appearance.

Each of the first hook shaped arms 356 is secured to and extends radially outwardly and axially from the circumferential skirt 326 to define a first open pocket 360 away from the axial portion 320 and between the free-edge rim 330 and the first hook shaped arm 356. Similarly, each of the second hook shaped arms 358 is secured to and extends radially outwardly and axially from the circumferential skirt 326 to define a second open pocket 362 away from the axial portion 320 and between the free-edge rim 330 and the second hook shaped arm 358. The open pockets 360, 362 allow for radial deflection and at least one (or both) of tangential and axial deflection of the flexural members 346, 348, 350 when engaging or disengaging from the filter head 400.

In the example shown, each of the arm arrangements 354 extends from a respective one of the ribs 336-341. Each of the interface members 352 is centered between two of the ribs 336-341.

The arm arrangement 354 is positioned radially outside of the circumferential skirt 326. Each interface member 352 extends at least 1-25 mm away from the exterior surface 322 of the axial portion 320. In some embodiments, the interface member 352 extends a greater distance away from the exterior surface 322 of the axial portion 320 than the open spigot 332. In other embodiments, the interface member 352 extends a smaller distance away from the exterior surface 322 of the axial portion 320 than the open spigot 332. In still other embodiments, the interface member 352 extends an equal distance away from the exterior surface 322 of the axial portion 320 as the open spigot 332.

In this example embodiment, the flexural member 346, 348, 350 is radially spaced from the circumferential skirt 326 by a selected distance. This radial spacing allows the flexural member 346, 348, 350 to deflect radially inwardly or outwardly during installation and removal of the filter cartridge 300. In examples, the radial spacing is between 2 mm and 9 mm, and is no greater than 10 mm. The radial flexibility of the flexural member 346, 348, 350 can include only part of or the entire flexural member 346, 348, 350. For example, the radial flexibility can include only the interface member 352, or the interface member 352 and all or only portions of the arm arrangement 354. Any radial motion, including twisting motion that includes a radial component, is considered “radial flexibility” herein.

In example embodiments, a distance of radial flexibility of the flexural member 346, 348, 350 from the skirt 326 compared to a diameter of the first end construction is between, for example, 0.7% and 16%; in other examples, between 1% and 14%.

In preferred arrangements, the flexural members 346, 348, 350, including both the interface member 352 and the arm arrangement 354 is a single, molded piece of material. It can also be molded with the first end construction 314. The flexural members 346, 348, 350 can be made from a variety of materials including, for example, non-metal, such as plastic including, for example glass-filled nylon. The material can have a Flexural Modulus of 1-10 GPa, preferably 4-9 GPa, per ASTM D790. Alternatively, the material can be metal and have a Flexural modulus of 13-400 GPa per ASTM D790.

Preferred arrangements and how the “click” sound is produced are discussed below, in connection with the interaction between the cartridge 300 and the filter head 400.

In accordance with additional principles of this disclosure, the filter cartridge 300 includes a blocking piece 363 (FIG. 15) to ensure proper engagement between the filter cartridge 300 and a receiving member, such as filter head 400. The blocking piece 363 extends radially outwardly from the first end construction 314 and is circumferentially spaced adjacent to at least one of the ribs 336-341. In the example shown, there are a plurality of blocking pieces 363, 364, 365. The blocking pieces 363, 364, 365 are each adjacent to one rib of each rib pair. For example, the blocking piece 363 is adjacent to rib 336; blocking piece 364 is adjacent to rib 338; and blocking piece 365 is adjacent to rib 340. The blocking pieces 363-365 can have various configurations, such as a triangular shape, to ensure that the filter cartridge 300 can only be installed in the proper orientation.

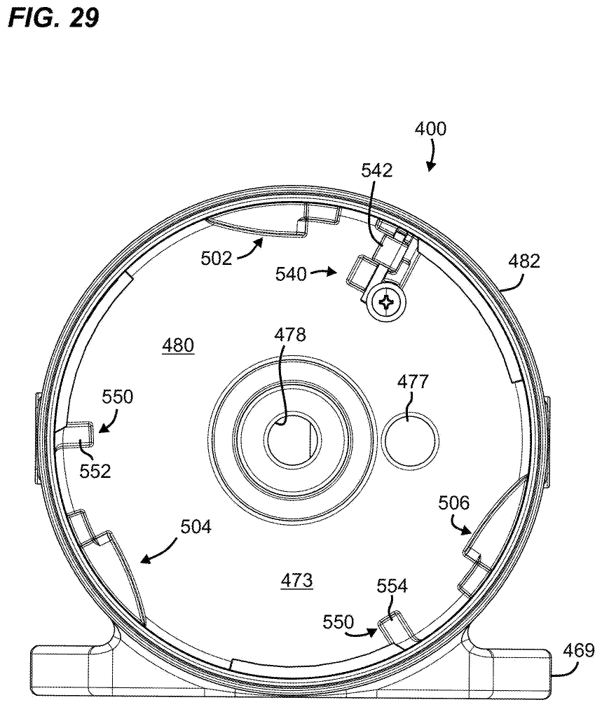

The first end construction 314 optionally further includes at least one actuator arrangement 372 (FIG. 15) positioned on the axial portion 320 of the first end construction 314. The actuator arrangement 372 is constructed and arranged to push a displaceable piece 540 (FIGS. 29-34) on mating filter head 400 from a blocking position to a clearance position. In the example shown, the actuator arrangement 372 comprises a plurality of ramps 366, 368, and 370 on the axial portion 320 of the first end construction 314. The ramps 366, 368, 370 are circumferentially spaced from each other and circumferentially spaced from the flexural members 346, 348, 350. Each ramp 366, 368, 370 is in alignment with a respective one of the ribs in each rib pair. For example, ramp 366 is in alignment with rib 336; ramp 368 is in alignment with rib 338; and rib 370 is in alignment with rib 340. In preferred embodiments, each of the ramps 366, 368, 370 is located on the axial portion 320 along the outer rim 319.

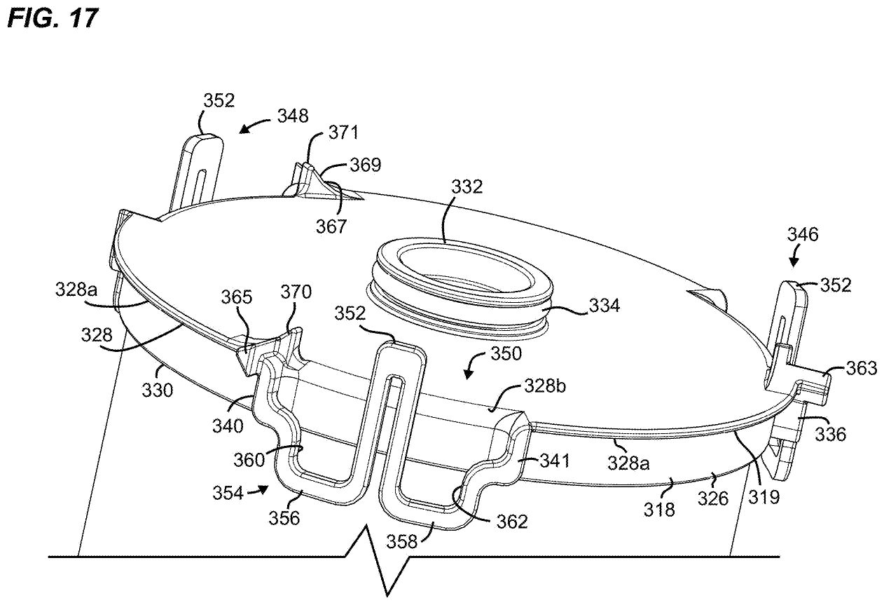

Each ramp 366, 368, 370 is constructed and arranged to push the displaceable piece 540 (FIGS. 29-34) on mating filter head 400 from a blocking position to a clearance position. In the example of FIG. 17, each ramp 366, 368, 370 includes a slope surface 367 having a curved ramp surface 369 ending in a free end tip 371. In this example, the displaceable piece 540 is pushed along the slope surface 367 of the ramps 366, 368, 370.

The ramps 366, 368, 370 extend from the axial portion 320 at a peripheral edge thereof and ramp upwardly in a direction away from the axial portion 320. Each ramp 366, 368, 370 has a slope selected to effectively engage and displace a displaceable piece on filter head 400 during installation. For example, the curved ramp section 369 has an average slope from the axial portion 320 to the free end tip 371 in the range of 7-65°. In some embodiments, the slope surface 367 of each ramp 366, 368, 370 extends from the free end tip 371 to the axial portion 320 in a clockwise direction, when viewed from a position above the first end construction 314. In some embodiments, each ramp 366, 368, 370 is positioned along the outer rim 319 and bridges between one of the non-lip sections 328b and an adjacent lip section 328a.

The filter cartridge 300 is configured for out-to-in flow during filtering. Unfiltered liquid is directed into an annulus between an outside of the media 308 and an interior surface of a filter bowl, and then through the media 308 and into the interior volume 310. The filtered liquid is then directed upwardly through the open spigot 332 and back into the filter head for exit.

### Filter Bowl and Bowl-Cartridge of FIGS. 19-22

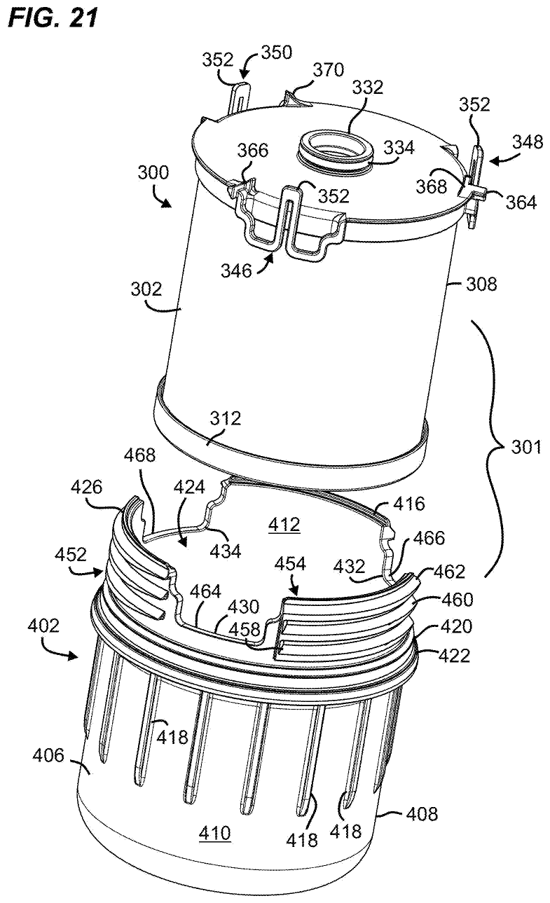

An example bowl-cartridge filter assembly 301 is depicted in FIGS. 21 and 22, and includes outer housing or bowl 402 and removable and replaceable filter cartridge 300. During servicing, the filter assembly 301 is removed from the filter head 400; the filter cartridge 300 is removed from the bowl 402 and discarded. An entirely new filter cartridge 300 is provided and inserted into the filter bowl 402 and then, the bowl-cartridge filter assembly 301 is again attached to the filter head 400. In an alternative arrangement, the bowl 402 is mounted and fixed, while the filter head is a removable cover.

In FIG. 22, a central longitudinal axis 404 is depicted, around which the filter assembly 301 is positioned. The terms “axial”, “axially” and variants thereof, as used herein, is generally meant to refer to a feature extending in the general direction of the axis 404. The terms “radial”, “radially”, and variants thereof, are meant to refer to a direction toward or away from the axis 404.

The bowl-cartridge filter assembly 301 is shown in perspective view in FIG. 22 and in exploded view in FIG. 21. The filter bowl 402 includes an external can or shell 406 that has a surrounding wall 408. The surrounding wall 408 has an exterior surface 410 and an opposite interior surface 412. There is a closed bottom 414 and an opposite mouth 416 that interfaces with the filter head 400.

The shell 406 can include a plurality of anti-slip ribs 418 circumferentially spaced about the shell 406 adjacent to the mouth 416. The ribs 418 can be helpful for the user to be able to apply a grip on the assembly 301, when attaching or removing the assembly 301 and the filter head 400.

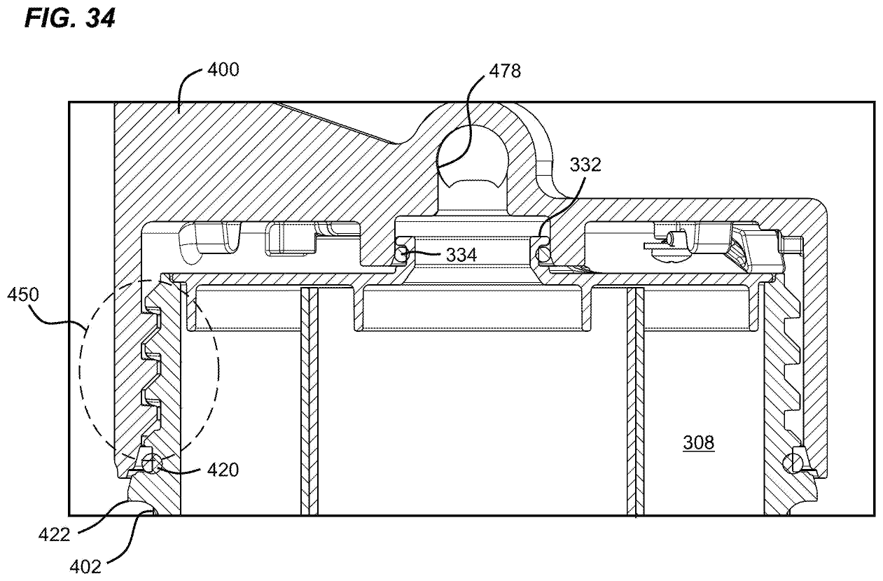

The bowl 402 holds a seal member 420 to form a seal between the filter head 400 and the bowl 402 to prevent fluid leaking from the assembly 301 into the surrounding environment. In the example shown, the seal member 420 is against the exterior surface 410 of the wall 408 of the bowl 402. The seal member 420 is positioned just above and against a stop member 422 radially projecting from a remaining part of the wall 408 of the bowl 402. As explained below, there is a connection system 450 (FIG. 34), and the seal member 420 is between the stop member 422 and the connection system 450. The connection system 450 is immediately adjacent to the mouth 416 of the bowl 402, such that the connection system 450 is located axially between the mouth 416 and the seal member 420.

Typically, the outer shell 406 may be metal or plastic. The shell 406 defines an interior volume 424. Within the interior volume 424 is positioned the filter cartridge 300.

In the example arrangement shown, the mouth 416 of the bowl 402 is defined by an end rim 426. The inner ledge 321 is along the end rim 426 on the interior surface 412. As can be seen in FIGS. 19-21, the mouth 416 has a plurality of recessed sections 430, 432, 434. When the filter cartridge 300 is operatively positioned within the bowl 402, the ribs 336 engage against the rim 426, within the recessed sections 430, 432, 434 of the bowl 402. Each interface member 352 is centered within a respective one of the recessed sections 430, 432, 434. Each arm arrangement 354 extends across a respective one of the recessed sections 430, 432, 434.

When the filter cartridge 300 is installed in the bowl 402 and connected to the filter head 400, the inlet flow path includes the inlet liquid flowing into an annulus 436 (FIG. 22) between the outer perimeter of the media 308 and the inside surface of the filter head 400, in the recessed sections 430, 432, 434. That is, the inlet flow travels through the open pockets 360, 362 (FIG. 18) formed by the first and second hook shaped arms 356, 358.

In accordance with principles of this disclosure, the filter cartridge 300 includes a system to allow for a low friction installation of the filter assembly 301 to the filter head 400 and results in a reliable seal compression, including simply inserting and rotating the filter assembly 301 less than a full turn. In this embodiment, the system includes the connection system 450. The connection system 450 will allow for low friction insertion and turning of the cartridge 300 less than 180° for example, about 60° and result in a reliable seal compression. The connection system 450 eliminates cross-threading, and lends itself to having the connectors be specific to specific customers.

In the example embodiment illustrated, the connection system 450 includes a plurality of circumferentially spaced connecting sections, illustrated herein as 452, 454, and 456 located on the filter assembly 301, and in the example shown, the bowl 402. In alternatives, the plurality of connecting sections may be, instead, a single connection section, such as a screw thread. Each connecting section 452, 454, 456 can include screw threads, or preferably and as shown in the drawings, a plurality of helical profiles 458, 460, 462. The connecting sections 452, 454, 456 may be identical, or may be unique, including differences in thickness or height to accommodate different stress loads. For some embodiments there may be an advantage in having only one alignment position. The number of aligning positions depends on the number of connecting sections, and whether they are unique or identical.

Each of the helical profiles 458, 460, 462 extends circumferentially along and projecting from the exterior surface 410 of the surrounding wall 408 of the bowl 402. By “helical profile”, it is meant the geometrical outline along an outermost border which, if continued, would have a general spiral shape. Although in some embodiments, screw threads can be used, a helical profile is not a screw thread. In a helical profile, a plane perpendicular to the central longitudinal axis will pass through more than one profile, whereas in a screw thread, a plane perpendicular to the central longitudinal axis will pass through only one thread profile.

Preferably, each connecting section 452, 454, 456 is identical to the other connecting sections 452, 454, 456. This means that when mounting the bowl-cartridge assembly 301 onto the filter head 400, the user does not have to be concerned about matching the correct connecting section 452, 454, 456 with the particular receiving connecting segments on the filter head 400.

Preferably, the exterior surface 410 of the surrounding wall 408 has a plurality of alternating circumferentially spaced connecting sections 452, 454, 456 and alternating non-connecting sections 464, 466, 468. In the example shown, the recessed sections 430, 432, 434 form the non-connecting sections 464, 466, 468.

### The Filter Head & Variations, FIGS. 23-29

FIGS. 23-29 depict filter head 400. There are three embodiments of the filter head 400. Common parts have common reference numbers. Only the different parts will have new reference numbers.

The filter head 400 is typically installed on equipment, in a liquid line, for example a fuel line, hydraulic line or lubricating fluid (oil) line. During servicing the filter head 400 would typically remain in place in the equipment.

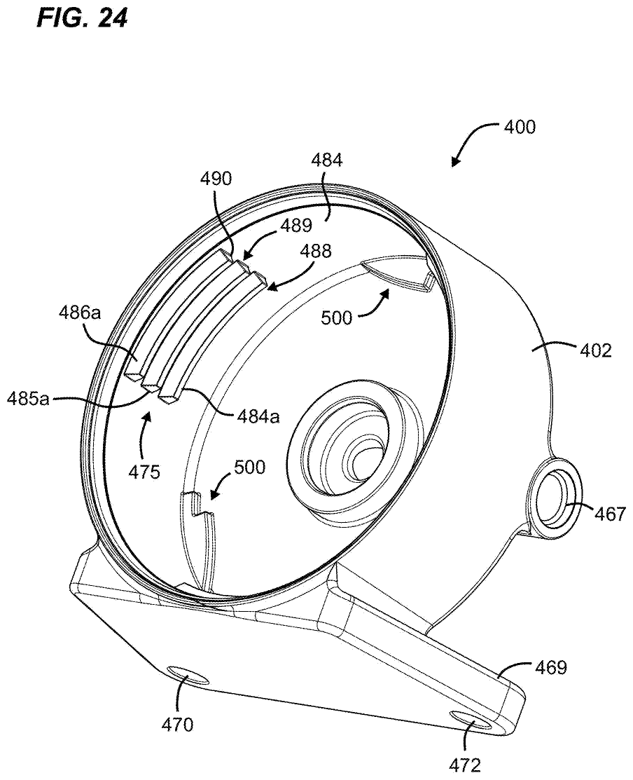

Still in reference to FIGS. 23-29, the filter head 400 includes a liquid flow inlet 465 (FIG. 23) and a liquid flow outlet 467 (FIG. 24). During operation, liquid to be filtered is directed into the filter head 400 through the inlet 465. Liquid is then directed through the filter arrangement 301 for filtration. The filtered liquid is then returned to the filter head 400 to exit through the outlet 467.

In a typical system, the filter head 400 comprises a cast metal part, for example, cast aluminum, with various features added thereto. The filter head 400 may also be plastic, made by a plastic injection molding process, for example.

While many embodiments are possible, in the one shown, the filter head 400 includes a flange 469 (FIG. 24), which can have bolt holes 470, 472 for securing the filter head 400 to the equipment.

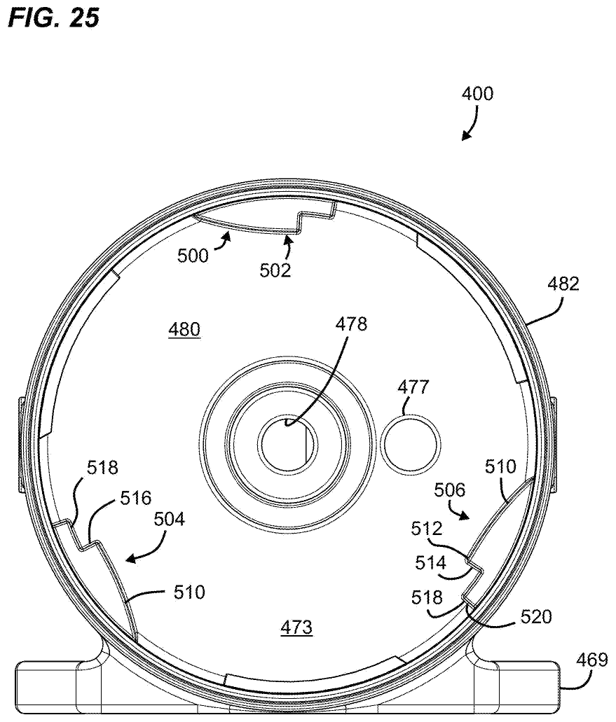

In reference now to FIG. 25, an end wall 480 is shown, which will typically include an inlet opening 477 in communication with the inlet 465, to allow for the flow of liquid from the filter head 400 into the filter arrangement. End wall 480 will also have an outlet opening 478 to allow for the flow of filtered liquid from the filter arrangement into the filter head 400 to allow it to exit through the outlet 467. The end wall 480 has an inner surface 473.

Extending axially from the end wall 480 is a surrounding wall 482 with an exterior surface 483 and an opposite interior or inner radial surface 484.

In accordance with principles of this disclosure, the connection system 450 includes circumferentially spaced sets of connecting segments constructed and arranged to mate with the connecting sections of the bowl-cartridge assembly 301. The inner radial surface 484 of the filter head 400 includes a plurality of circumferentially spaced sets 474, 475, 476 of connecting segments 484a, 485a, 486a constructed and arranged to mate with the connecting sections of the bowl-cartridge assembly 301. The connecting sets 474, 475, 476 are circumferentially spaced along the inner radial surface 484 and are separated by smooth, ungrooved, portions 488, 489, 490 of the inner radial surface 484.

Each connecting segment 484a, 485a, 486a comprises a helical groove or recess extending along the inner radial surface 484 of the surrounding wall 482 of the filter head 400. The connecting segments 484a, 485a, 486a are constructed and arranged to receive and engage the helical profiles 458, 460, 462 projecting from the connecting sections 452, 454, 456 of the bowl 402. During installation, the bowl-cartridge assembly 301 is first inserted axially into the filter head 400 such that the helical profiles 458, 460, 462 align with and enter the connecting segments 484a, 485a, 486a through the smooth, ungrooved portions 488, 489, 490. The bowl-cartridge assembly 301 is then rotated relative to the filter head 400, causing the helical profiles 458, 460, 462 to travel along the helical grooves of the connecting segments 484a, 485a, 486a, thereby drawing the bowl-cartridge assembly 301 further into engagement with the filter head 400 and compressing the seal members. The helical engagement between the connecting sections 452, 454, 456 and the connecting segments 484a, 485a, 486a provides a secure mechanical connection that resists separation during operation.

As described above in connection with the filter cartridge 300, the click device 344 can include flexural members 346, 348, 350, each including interface member 352. During installation, these flexural members 346, 348, 350 interact with corresponding click-device engagement members on the filter head 400 to produce an audible click.

In reference now to FIGS. 23-26 and 29, the filter head 400 includes a first embodiment of at least one click-device engagement member 500 that cooperates with the interface members 352 on the filter cartridge 300 to provide installation feedback. In the example shown, the click-device engagement member includes at least one projection 502, and preferably, a plurality of projections 502. In the examples shown, there are three circumferentially spaced projections 502, 504, 506. In this example, the projections 502, 504, 506 are located on the inner surface 473 of the end wall 480 and against the inner radial surface 484 of the surrounding wall 482.

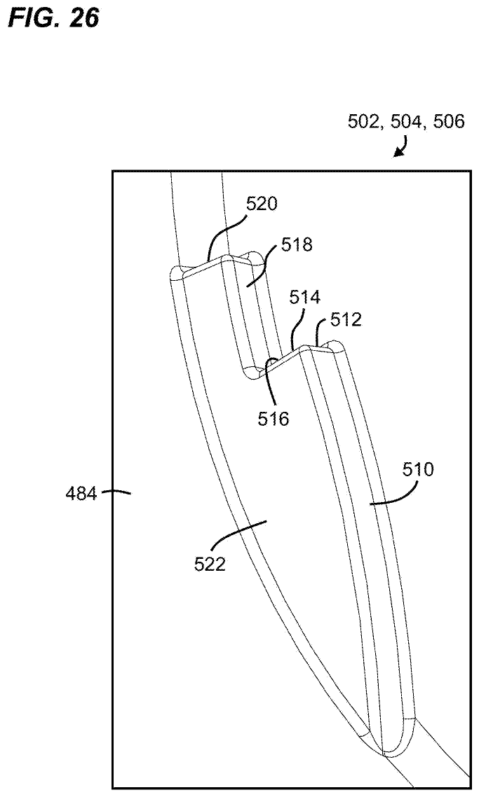

While many embodiments are possible, in the arrangement shown and in reference to FIG. 26, each of the projections 502, 504, 506 includes an angled slide surface 510. The slide surface 510 is angled radially inwardly from the inner radial surface 484 of the surrounding wall 482. The slide surface 510 is at an angle ranging from 12-50°, such as 15-45°, for example 20-30°, such as about 23-27°. The slide surface 510 ends at an edge 512, which intersects with a cliff wall 514. Together the edge 512 and cliff wall 514 form a cliff 516. At the bottom of the cliff 516, intersecting the cliff wall 514 is a snap surface 518. The snap surface 518 extends to an end wall 520.

During installation of the bowl-cartridge assembly 301 onto the filter head 400, the interface members 352 slide along the slide surface 510 of the projections 502, 504, 506 as the assembly 301 is rotated. The flexural members 346, 348, 350 deflect radially inwardly as the interface members 352 travel up the slide surfaces 510 until reaching the edge 512. Once the interface members 352 pass over the cliff 516, the flexural members 346, 348, 350 elastically snap back, causing the interface members 352 to move and engage against (or strike) the snap surface 518. This snapping action produces an audible noise or click. Preferably, the noise is in a range of 40-80 dBA. The audible click provides feedback to inform the user that the filter cartridge 300 has been properly installed on the filter head 400. The interaction between the interface members 352 and projections 502, 504, 506 also helps to prevent the filter cartridge 300 from backing off of the filter head 400 due to vibration during operation, or due to internal system pressure.

As mentioned above, the audible noise or click produced is in a range of 40-80 dBA. Unless stated otherwise, sound pressure levels are expressed in decibels (dB) referenced to 20μPa in accordance with ISO 1683. Measurements of A weighted sound pressure level are obtained using an IEC 61672 compliant sound level meter operating with the FAST time weighting (LAF). In some embodiments, measurements are collected at a distance of 0.5 m from the source in an acoustic test environment in which background noise does not materially influence the result, typically being at least 10 dB below the measured sound pressure level. These measurement conditions are provided for illustration and do not limit the scope of the appended claims.

Conversely, when removing the assembly 301 from the filter head 400, the bowl 402 is rotated in the removal direction, which is opposite the installation direction. As the bowl 402 rotates, the interface members 352 move over the cliff 516 by either or both tangential motion and axial motion of the flexural members 346, 348, 350. The interface members 352 then slide along a slide face 522. The slide face 522 is the upper face of the projection 502, and is generally orthogonal to the slide surface 510. The interface members 352 move along the slide face 522 until they elastically move off of the slide face 522 and away from the projection 502, allowing the bowl-cartridge assembly 301 to be separated from the filter head 400.

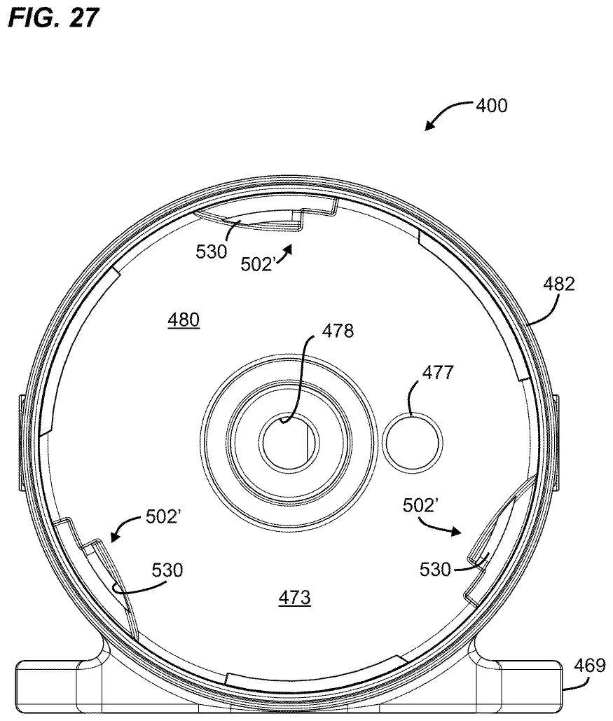

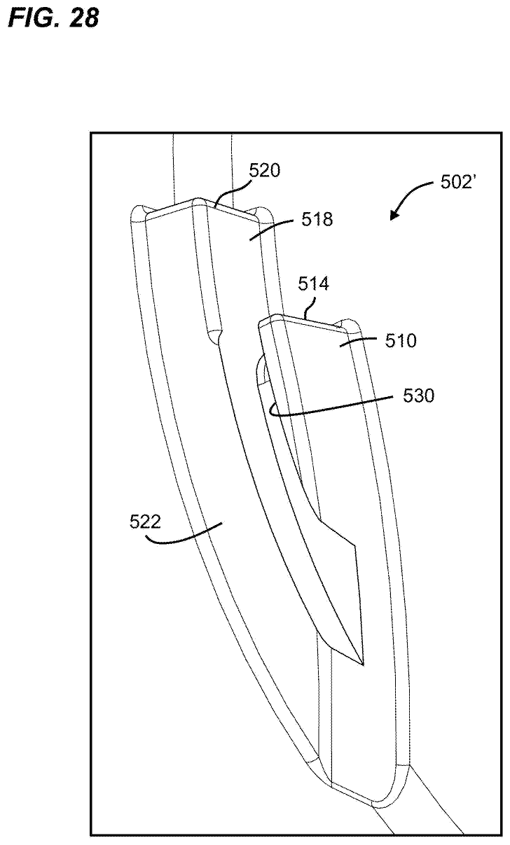

In reference now to FIGS. 27 and 28, a variation of the projection 502 is illustrated at 502′. In this embodiment, the projection 502′ further includes a slide groove 530. As shown in FIG. 28, the slide groove 530 extends between the cliff wall 514 and the slide surface 510. The slide groove 530 is recessed into the projection 502′ and provides a defined path for the interface member 352 to move within during the removal process.

During removal of the bowl-cartridge assembly 301 from the filter head 400, as the bowl 402 is rotated in the removal direction, the interface member 352 enters the slide groove 530. The slide groove 530 guides the interface member 352 along a controlled path as it travels toward and onto the slide face 522. By providing this guided path, the slide groove 530 helps to ensure consistent and predictable movement of the interface member 352 during disengagement.

In embodiments without the slide groove 530 (FIGS. 23-26 and 29), the interface member 352 moves over the cliff 516 and directly onto the slide face 522 without following a defined groove path. Both configurations are effective for allowing disengagement of the filter cartridge 300 from the filter head 400.

### Displaceable Piece of Filter Head 400, FIGS. 29-36

In accordance with additional principles of this disclosure, there is provided a system to make sure that if the wrong or incomplete filter is attempted to be attached to the filter head 400, it will not work-it will be inoperable. In general, the filter head 400 has a displaceable piece, the displaceable piece being positioned to move from a blocking position to a clearance position when engaged with the filter arrangement 301 and permit connection therebetween.

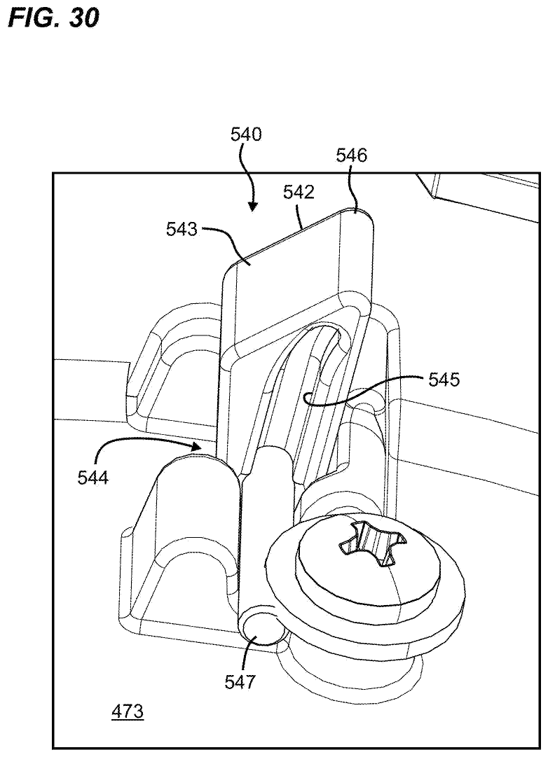

In reference now to FIGS. 29-30, the filter head 400 includes a displaceable piece 540 in the form of a moveable arm, such as pivotable pin 542. In FIGS. 29 and 30, the pin 542 is shown extending upright from the inner surface 473 of the end wall 480. The pin 542 has a generally rectangular ramp engagement face 543. When upright, the pin 542 extends partially (not fully) along the inner radial surface 484 of the surrounding wall 482. The pin 542 is located along the outermost periphery of the end wall 480.

In FIG. 30, it can be seen that, in this embodiment, the pin 542 has a pivot (or hinge) arrangement 544, via a groove 545 accommodating a hinge pin 547. The pivot arrangement 544 allows the pin 542 to pivot 90 degrees from the upright position shown in FIGS. 29-30 to a down position, shown in FIG. 34, and also from the down position (FIG. 34) to the upright position (FIGS. 29-30). The down position includes the pin 542 lying against the inner surface 473 of the end wall 480. That is, the pin 542 has a free end 546, and the free end 546 moves from being spaced away from the inner surface 473 of the end wall 480 (FIGS. 29-31) to adjacent to the inner surface 473 of the end wall 480 (FIG. 34). In use, the upright position of FIGS. 29-31 is a blocking position, preventing connection with the filter head 400. The down position of FIG. 34 is a clearance position, allowing connection with the filter head 400.

As described above in connection with the filter cartridge 300, the first end construction 314 includes actuator arrangement 372, which in the example shown comprises the plurality of ramps 366, 368, 370 (FIGS. 17, 18) on the axial portion 320 of the first end construction 314. The ramps 366, 368, 370 are constructed and arranged to push the displaceable pin 542 on the filter head 400 from the blocking position to the clearance position.

Each ramp 366, 368, 370 includes slope surface 367 having curved ramp surface 369 ending in free end tip 371. Each ramp 366, 368, 370 extends from the axial portion 320 at a peripheral edge thereof and ramps upwardly in a direction away from the axial portion 320. Each ramp 366, 368, 370 has a slope selected to effectively engage and displace the displaceable pin 542 on filter head 400 during installation. The curved ramp surface 369 has an average slope from the axial portion 320 to the free end tip 371 of 7-65°.

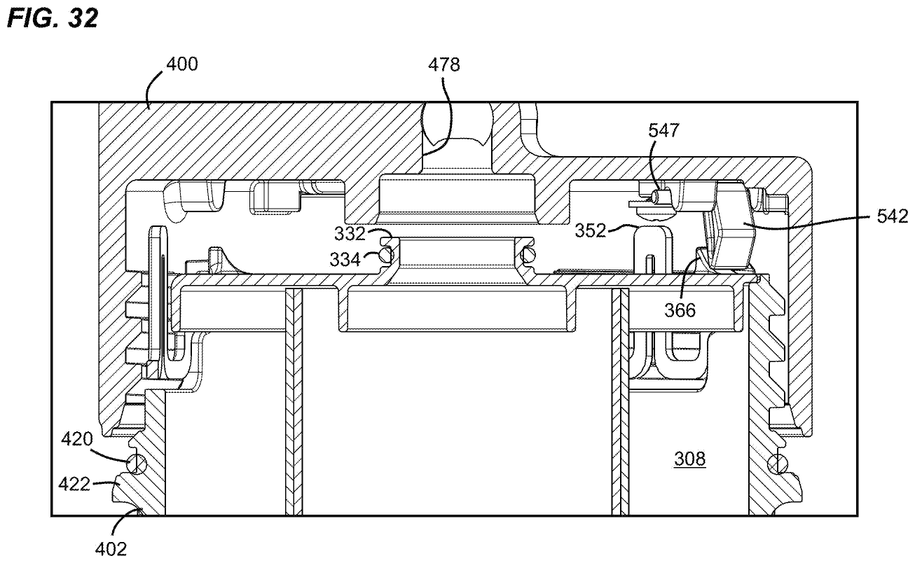

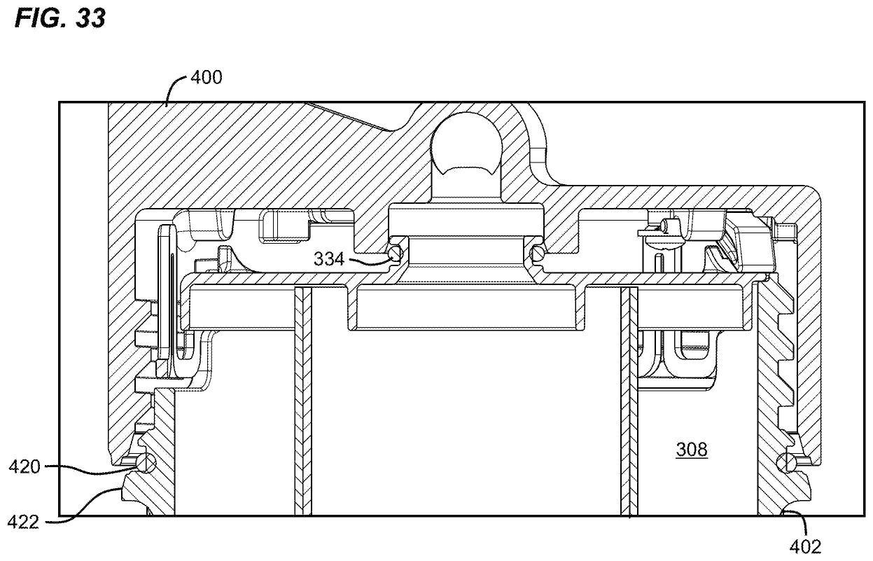

During installation of the bowl-cartridge assembly 301 onto the filter head 400, the ramps 366, 368, 370 interface with the pin 542. As shown in FIG. 31, as the bowl-cartridge assembly 301 is inserted axially into the filter head 400, at least one of the ramps 366, 368, 370 engages the pin 542 to begin pivoting it about the pivot arrangement 544 from the upright blocking position. As the filter assembly 301 is rotated relative to the filter head 400, the ramps 366, 368, 370 continue to guide the pin 542 toward the clearance position. FIGS. 32 and 33 illustrate intermediate steps of installation as the ramps 366, 368, 370 progressively displace the pin 542. FIG. 34 shows the fully installed position, with the pin 542 in the clearance position lying against the inner surface 473 of the end wall 480, allowing the bowl-cartridge assembly 301 to fully engage with the filter head 400. The pin 542 pivots in a direction opposite of the rotation direction of the filter assembly 301.

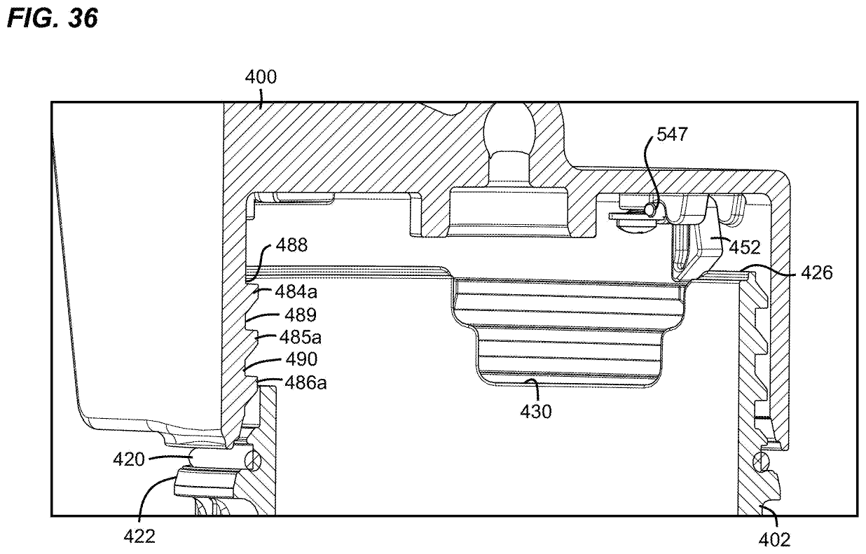

FIG. 36 illustrates the blocking function of the pin 542, showing an attempted connection of the bowl 402 to the filter head 400 without the filter cartridge 300 present. In this scenario, because the ramps 366, 368, 370 are not present, the pin 542 remains in the blocking position and prevents the bowl 402 from connecting to the filter head 400.

### Method of Mounting Filter Assembly 301 to Filter Head 400

A method of mounting the filter assembly 301 to the filter head 400 is provided and illustrated in FIGS. 31-34. The method comprises inserting the filter assembly 301 into the filter head 400 to displace the displaceable pin 542 on the filter head 400 (FIG. 31). The step of inserting includes using the first end construction 314 on the filter assembly 301, and using the actuator arrangement 372, for example, at least one ramp 366, 368, 370 positioned on the axial portion 320 of the first end construction 314, to push the displaceable pin 542 from the blocking position toward the clearance position.

The method further includes rotating the filter assembly 301 relative to the filter head 400 to move the pin 542 from the blocking position to the clearance position to permit connection between the filter assembly 301 and the filter head 400 (FIGS. 32, 33, 34). The step of rotating includes using the first end construction 314 on the filter assembly 301 to pivot the pin 542. As the assembly 301 rotates, the ramps 366, 368, 370 continue to engage and guide the pin 542 until it reaches the clearance position (FIG. 34).

Preferably, the filter assembly 301 includes the filter cartridge 300 removably oriented within the filter bowl 402. The step of rotating includes rotating the filter assembly 301 less than 90°to engage connections between the filter bowl 402 and the filter head 400.

In preferred embodiments, the plurality of ramps 366, 368, 370 are circumferentially spaced from each other on the axial portion 320, and each ramp of the plurality of ramps is used to push the displaceable pin 542 from the blocking position to the clearance position as the assembly 301 is rotated. Each ramp 366, 368, 370 is in alignment with a respective one of the ribs 336, 338, 340 of the plurality of rib pairs projecting radially from the circumferential skirt 326 of the first end construction 314.

### Protrusions for Removal Assistance

The filter head 400 of FIGS. 29-36 includes at least one protrusion 550 positioned to assist during removal of the filter cartridge 300 from the filter head 400. While a single protrusion 550 may be used, the filter head 400 can include a plurality of protrusions. In the example shown, there are two protrusions 552, 554. The protrusions 552, 554 are circumferentially spaced from each other on the inner surface 473 of the end wall 480 and are positioned against the inner radial surface 484 of the surrounding wall 482.

During normal operation, the spigot 332 of the filter cartridge 300 extends into and can become seated within the outlet opening 478 of the filter head 400. Over time, or due to seal compression and system pressure, the spigot 332 can become stuck in the outlet opening 478, making removal of the bowl-cartridge assembly 301 from the filter head 400 more difficult. The protrusions 552, 554 provide a mechanical advantage to assist with disengagement of the filter cartridge 300 from the filter head 400 during the removal process.

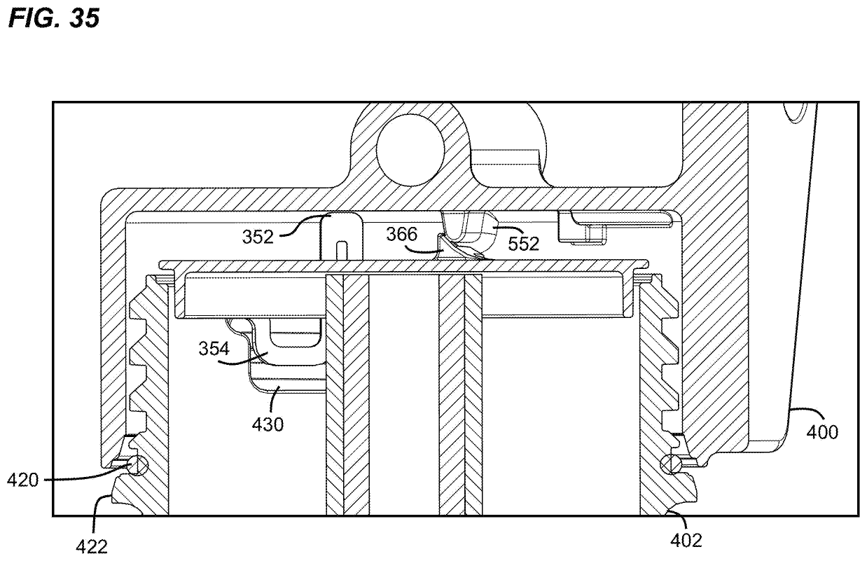

As shown in FIG. 35, when removing the bowl-cartridge assembly 301 from the filter head 400, as the bowl 402 is rotated in the removal direction, the ramps 366, 368, 370 on the filter cartridge 300 can engage against the protrusions 552, 554. This engagement creates a camming action that helps to nudge or axially move the filter cartridge 300 away from the filter head 400. The interaction between the ramps 366, 368, 370 and the protrusions 552, 554 provides additional force to dislodge the spigot 332 from the outlet opening 478, facilitating easier removal of the bowl-cartridge assembly 301 from the filter head 400.

### Method of Filtering

A method of filtering liquid using the filter assembly described herein is provided. The method comprises first assembling the filter cartridge 300 with the filter bowl 402 and filter head 400, and then operating the assembled system to filter liquid.

In assembling the system, the method includes placing the filter cartridge 300 into the filter bowl 402 to provide a bowl-cartridge combination or assembly 301. The cartridge 300 has at least one flexural member 346, 348, 350, and in preferred embodiments, a plurality of circumferentially spaced flexural members 346, 348, 350 extending radially from the first end construction 314. Each flexural member 346, 348, 350 includes an interface member 352.

The method further includes mounting the bowl-cartridge combination 301 on the filter head 400. The step of mounting includes inserting the filter assembly 301 into the filter head 400. During insertion, at least one ramp 366, 368, 370 positioned on the axial portion 320 of the first end construction 314 pushes a displaceable piece 540 on the filter head 400 from a blocking position toward a clearance position. The displaceable piece 540 comprises a pivotable pin 542 on the filter head 400 positioned to pivot between the blocking position and the clearance position. This step can be accomplished regardless of whether the filter cartridge 300 includes flexural members.

The method continues with rotating the bowl-cartridge combination 301 less than 90° relative to the filter head 400 to engage connections between the filter bowl 402 and the filter head 400. The step of rotating includes using the first end construction 314 on the filter assembly 301 to pivot the pin 542 from the blocking position to the clearance position to permit connection between the filter assembly 301 and the filter head 400. As the assembly 301 rotates, the ramps 366, 368, 370 continue to engage and guide the pin 542 until it reaches the clearance position.

During rotation, the helical profiles 458, 460, 462 on the connecting sections 452, 454, 456 of the bowl 402 engage with and travel along the helical grooves of the connecting segments 484a, 485a, 486a on the filter head 400, thereby drawing the bowl-cartridge assembly 301 further into engagement with the filter head 400.

Concurrently, while rotating, the method includes compressing a seal member 334 on the filter cartridge 300 to form a seal between and against the filter head 400 and the filter cartridge 300. The method also includes compressing the seal member 420 on the bowl 402 between and against the inner radial surface 484 of the surrounding wall 482 of the filter head 400 and the exterior surface 410 of the wall 408 of the bowl 402.

As the rotation continues, the flexural members 346, 348, 350 interact with projections 502, 504, 506 on the filter head 400. The step of snapping the flexural members 346, 348, 350 over the projections 502, 504, 506 includes deflecting the flexural members 346, 348, 350 in a radial direction over the projections 502, 504, 506 in the filter head 400. Preferably, deflecting the flexural members 346, 348, 350 in a radial direction includes deflecting the flexural members 346, 348, 350 radially inwardly over the projections 502, 504, 506 in the filter head 400. The interface members 352 slide along the slide surfaces 510 of the projections 502, 504, 506 as the assembly 301 is rotated. The flexural members 346, 348, 350 deflect radially inwardly as the interface members 352 travel up the slide surfaces 510 until reaching the edge 512.

Once the interface members 352 pass over the cliff 516, the flexural members 346, 348, 350 elastically snap back, causing the interface members 352 to move against the snap surface 518. This snapping action produces an audible click of at least 40-80 dBA. In preferred embodiments where there are a plurality of flexural members 346, 348, 350, each of the flexural members 346, 348, 350 produces an audible click of at least 40-80 dBA. The audible click provides feedback to inform the user that the filter cartridge 300 has been properly installed on the filter head 400. There are many different ways one can produce an audible click, and the interface members 352 are just one example embodiment.

Once the bowl-cartridge assembly 301 is properly installed on the filter head 400, the method includes operating the system to filter liquid. Liquid to be filtered is directed into the filter head 400 through the inlet 465. The liquid flows from the filter head 400 through the inlet opening 477 and into the annulus 436 between the outer perimeter of the media 308 and the inside surface of the filter head 400. The liquid passes through the filter media 308, filtering contaminants therefrom, and into the interior volume 310. The filtered liquid is then directed upwardly through the open spigot 332 and back into the filter head 400 through the outlet opening 478 to exit through the outlet 467.

The method may further include, before the step of placing a new filter cartridge 300 into the filter bowl 402, removing a used filter cartridge from the filter bowl 402. The step of removing includes rotating the used filter cartridge, while mounted in the filter bowl 402, relative to the filter head 400. During removal, the interface members 352 move over the cliff 516 by either or both tangential motion and axial motion of the flexural members 346, 348, 350 to move the flexural members 346, 348, 350 on the used filter cartridge over the projections 502, 504, 506 in the filter head 400.

In some embodiments, the step of removing includes engaging the ramps 366, 368, 370 on the used filter cartridge 300 against protrusions 552, 554 in the filter head 400 to axially move the used filter cartridge 300 away from the filter head 400. This engagement creates a camming action that helps to dislodge the spigot 332 from the outlet opening 478, facilitating easier removal of the bowl-cartridge assembly 301 from the filter head 400.

The above represents example principles. Many embodiments can be made using these principles.

1. A filter cartridge comprising
(a) a treatment media construction having a first end and an opposite second end;
(b) a first end construction adjacent to the first end of the media construction; the first end construction having an outer periphery; and
(c) a flexural member along the outer periphery of the end construction;
(i) the flexural member being radially deflectable and at least one of: tangentially deflectable or axially deflectable.

2. The filter cartridge of claim 1, wherein:
(a) the treatment media construction comprises a cylindrical construction of pleated filter media defining an open interior volume; and
(b) the first end construction includes an opening providing communication with the open interior volume.

3. The filter cartridge of claim 2, wherein:
(a) the first end construction includes an axial portion having an exterior surface and an opposite interior surface, and a circumferential skirt extending from the interior surface of the axial portion; the circumferential skirt forming the outer periphery; the opening in the first end construction being defined by an open spigot; and
(b) the flexural member includes an interface member extending at least 1-25 mm axially spaced from the exterior surface of the axial portion.

4. The filter cartridge of claim 3, wherein:
(a) the open spigot extends a distance axially spaced from the exterior surface of the axial portion; and
(b) the interface member extends a greater distance away from the exterior surface of the axial portion than the open spigot.

5. The filter cartridge of claim 3, wherein:
(a) the open spigot extends a distance away from the exterior surface of the axial portion; and
(b) the interface member extends a smaller distance away from the exterior surface of the axial portion than the open spigot.

6. The filter cartridge of claim 3, wherein:
(a) the open spigot extends a distance away from the exterior surface of the axial portion; and
(b) the interface member extends an equal distance away from the exterior surface of the axial portion as the open spigot.

7. The filter cartridge of claim 3, further including a seal member held by the first end construction.

8. The filter cartridge of claim 7, wherein the seal member is mounted on the open spigot.

9. (canceled)

10. The filter cartridge of claim 3, wherein the first end construction includes a radially projecting lip arrangement between the axial portion and the circumferential skirt.

11. The filter cartridge of claim 10, wherein the flexural member is radially spaced from the circumferential skirt by a distance of no greater than 10 mm.

12. The filter cartridge of claim 3, wherein the interface member is supported by an arm arrangement.

13. The filter cartridge of claim 12, wherein the arm arrangement is positioned radially outside of the circumferential skirt.

14. The filter cartridge of claim 12, further including a plurality of flexural members circumferentially spaced along the outer periphery; each of the flexural members including its own interface member supported by a respective arm arrangement.

15. The filter cartridge of claim 14, further including:
(a) a plurality of ribs projecting radially from the circumferential skirt of the first end construction sized to engage a rim of a filter bowl, when the cartridge is inserted into a filter bowl; and
(b) wherein each of the flexural members is positioned between two of the ribs.

16. The filter cartridge of claim 15, wherein:
(a) each of the arm arrangements extends from a respective one of the ribs; and
(b) each of the interface members is centered between two of the ribs.

17. The filter cartridge of claim 14, wherein each of the arm arrangements includes a first hook shaped arm and a second hook shaped arm with the respective interface member therebetween.

18. The filter cartridge of claim 17, wherein:
(a) the circumferential skirt of the first end construction includes a free-edge rim;
(b) each of the first hook shaped arms is secured to and extends radially outwardly and axially from the circumferential skirt to define a first open pocket away from the axial portion and between the free-edge rim and the first hook shaped arm; and
(c) each of the second hook shaped arms is secured to and extends radially outwardly and axially from the circumferential skirt to define a second open pocket away from the axial portion between the free-edge rim and the second hook shaped arm.

19. (canceled)

20. The filter cartridge of claim 15, further comprising a blocking piece to ensure proper engagement between the filter cartridge and a receiving member; the blocking piece being circumferentially spaced adjacent to one of the ribs.

21. The filter cartridge of claim 20, wherein the blocking piece extends radially outwardly from the first end construction.

22. The filter cartridge of claim 1, wherein the first end construction further includes a ramp circumferentially spaced from the flexural member; the ramp being constructed and arranged to push a displaceable piece on a mating filter head from a blocking position to a clearance position.

23. The filter cartridge of claim 15, further including a plurality of ramps on the axial portion of the first end construction; the ramps being circumferentially spaced from each other; and each ramp being in alignment with a respective one of the ribs.

24. (canceled)

25. The filter cartridge of claim 1, wherein the flexural member is radially inwardly flexible.

26. The filter cartridge of claim 1, wherein the flexural member is radially outwardly flexible.

27. The filter cartridge of claim 1, wherein a distance of radial flexibility of the flexural member compared to a diameter of the first end construction is between 0.7% to 16%.

28. The filter cartridge of claim 3, wherein the flexural member is constructed and arranged such that to displace the flexural member radially by 1.2 mm at the interface member requires a force of 0.3 lbs to 10 lbs.

29. The filter cartridge of claim 3, wherein the flexural member is constructed and arranged such that to displace the interface member in a direction toward the treatment media construction by 2mm requires a force of between 0.2-15 pounds.

30. The filter cartridge of claim 1, wherein the flexural member comprises a material having a flexural modulus of 1-10 GPa, per ASTM D790.

31. The filter cartridge of claim 1, wherein the flexural member is configured to produce an audible click of at least 40-80 dBA, while the filter cartridge is connecting to a filter head, referenced to 20 μPa in accordance with ISO 1683.

32-33. (canceled)
